(19) United States
(12) Patent Application Publication
(10) Pub. No.: US 2011/0247523 A1
(43) Pub. Date: Oct. 13, 2011

(54) ORGANIC-INORGANIC COMPOSITE PARTICLES, PARTICLE DISPERSION, PARTICLE-DISPERSED RESIN COMPOSITION, AND METHOD FOR PRODUCING ORGANIC-INORGANIC COMPOSITE PARTICLES

(75) Inventors: Yoshiharu HATAKEYAMA, Osaka (JP); Junichi Nagase, Osaka (JP); Shusaku Shibata, Osaka (JP); Saori Fukuzaki, Osaka (JP); Tatsuki Nagatsuka, Osaka (JP); Takahiro Fukuoka, Osaka (JP); Tadafumi Ajiri, Miyagi (JP)

(73) Assignees: TOHOKU UNIVERSITY, Sendai-shi (JP); NITTO DENKO CORPORATION, Osaka (JP)

(21) Appl. No.: 13/084,843

(22) Filed: Apr. 12, 2011

(30) Foreign Application Priority Data
Apr. 12, 2010 (JP) 2010-091577
Jul. 30, 2010 (JP) 2010-172306

(51) Int. Cl. C08K 3/10; C08K 5/057; C07F 19/00; C08K 5/09

(52) U.S. Cl. 106/447; 106/505; 106/471; 524/398; 524/400; 556/1

(57) ABSTRACT

The organic-inorganic composite particles can be dispersed as primary particles in a solvent and/or a resin and have a plurality of mutually different organic groups on the surface of inorganic particles.

### CROSS-REFERENCE TO RELATED APPLICATIONS

This application claims the benefit of priority of Japanese Patent Application No. 2010-091577, filed on Apr. 12, 2010, and Japanese Patent Application No. 2010-172306, filed on Jul. 30, 2010, the entire contents of which are incorporated herein by reference.

### BACKGROUND OF THE INVENTION

1. Field of the Invention

The present invention relates to organic-inorganic composite particles, a particle dispersion, a particle-dispersed resin composition, and a method for producing organic-inorganic composite particles. Specifically, the present invention relates to a particle dispersion and a particle-dispersed resin composition for use in various industrial applications including optical applications, to organic-inorganic composite particles dispersed in such a dispersion and a composition, and to a production method therefor.

2. Description of Related Art

Nano-scale particles (nanoparticles) have been used in various industrial applications including optical applications.

For example, Japanese Unexamined Patent Publication No. 2005-194148 proposes dispersing, in a solvent or a resin, organic-modified fine particles obtained by a hydrothermal synthesis using metal oxide particles and an organic modifier.

### SUMMARY OF THE INVENTION

However, organic-modified fine particles are problematic in that the organic-modified fine particles agglomerate when they are blended in a solvent or a resin in a high proportion.

An object of the present invention is to provide organic-inorganic composite particles that can be dispersed uniformly or nearly uniformly as primary particles in a solvent and/or a resin even when blended in a high proportion and a production method therefor as well as a particle dispersion and a particle-dispersed resin composition containing the organic-inorganic composite particles.

The organic-inorganic composite particles of the present invention can be dispersed as primary particles in a solvent and/or a resin and have a plurality of mutually different organic groups on the surface of inorganic particles.

It is preferable that the organic-inorganic composite particles of the present invention are produced in a high-temperature solvent.

It is preferable that the organic-inorganic composite particles of the present invention are produced in high-temperature, high-pressure water.

In the organic-inorganic composite particles of the present invention, it is preferable that the plurality of organic groups are organic groups each having a different number of main-chain atoms and/or organic groups each having a different main-chain molecular structure, and it is preferable that the plurality of organic groups are hydrocarbon groups each having a different number of main-chain carbon atoms and/or hydrocarbon groups each having a different main-chain molecular structure.

In the organic-inorganic composite particles of the present invention, it is preferable that at least one of the plurality of organic groups is a functional group-containing organic group at least containing a functional group in a side chain or at a terminal, and when two or more of the organic groups are the functional group-containing organic groups, the organic groups each have a different functional group or a different number of main-chain atoms, and it is preferable that at least one of the plurality of organic groups is a functional group-containing hydrocarbon-based organic group containing at least a hydrocarbon group and a functional group bonded to the hydrocarbon group, and when two or more of the organic groups are the functional group-containing hydrocarbon-based organic groups, the hydrocarbon-based groups each have a different functional group or a different number of main-chain carbon atoms.

The particle dispersion of the present invention contains a solvent and the aforementioned organic-inorganic composite particles that are dispersed as primary particles in the solvent The particle-dispersed resin composition of the present invention contains a resin and the aforementioned organic-inorganic composite particles that are dispersed as primary particles in the resin.

The method for producing organic-inorganic composite particles of the present invention includes treating inorganic particles and a plurality of mutually different organic compounds at a high temperature to treat the surface of the inorganic particles with the plurality of organic compounds, the plurality of organic compounds contain organic groups and a linker that can be bonded to the surface of the inorganic particles, and the organic groups are mutually different.

The organic-inorganic composite particles of the present invention obtained according to the production method of the present invention can be dispersed as primary particles in a solvent and/or a resin in a high proportion, exhibiting excellent dispersibility in a solvent and/or a resin.

Accordingly, in the particle dispersion and the particle-dispersed resin composition of the present invention, organic-inorganic composite particles are dispersed highly uniformly. Moreover, it is possible that the organic-inorganic composite particles are dispersed highly uniformly in a high proportion.

As a result, a solution chemistry reaction can be uniformly and more efficiently carried out on the organic groups bonded to the inorganic particles in the particle-dispersed composition. In other words, modification of the organic groups of organic-inorganic composite particles can be performed uniformly.

The particle-dispersed resin composition obtained from the particle dispersion composition has excellent transparency, and a particle-dispersed resin article formed from the particle-dispersed resin composition maintains excellent transparency.

Therefore, the particle-dispersed resin article of the present invention can be used in various applications where transparency is required.

### DETAILED DESCRIPTION OF THE INVENTION

The organic-inorganic composite particles of the present invention can be dispersed as primary particles in a solvent and/or a resin and have a plurality of mutually different organic groups on the surface of inorganic particles.

Specifically, the organic-inorganic composite particles can be obtained by treating the surface of inorganic particles using organic compounds.

One kind of organic-inorganic composite particle may be used or two or more kinds may be used in combination.

Examples of inorganic compounds (starting inorganic substances) that form inorganic particles include oxide, composite oxide, carbonate, and the like.

Examples of inorganic substances that form inorganic particles include metals including metallic elements such as main group elements and transition elements; nonmetals including nonmetallic elements such as boron and silicon; inorganic compounds containing metallic elements and/or nonmetals; and the like.

Examples of metallic elements and nonmetallic elements (IUPAC, 1989) include, assuming that a border is created by boron (B) of the IIIB group, silicon (Si) of the IVB group, arsenic (As) of the VB group, tellurium (Te) of the VIB group, and astatine (At) of the VIM group in the long-form periodic table (IUPAC, 1989), these elements and elements that are located on the left side as well as the lower side of the border in the long-form periodic table. Specific examples include the group IIIA elements such as Sc and Y; the group IVA elements such as Ti, Zr, and Hf; the group VA elements such as V, Nb, and Ta; the group VIA elements such as Cr, Mo, and W; the group VITA elements such as Mn and Re; the group VIII elements such as Fe, Co, Ni, Ru, Rh, Pd, Os, Ir, and Pt; the group IB elements such as Cu, Ag, and Au; the group IIB elements such as Zn, Cd, and Hg; the group MB elements such as B, Al, Ga, In, and Tl; the group IVB elements such as Si, Ge, Sn, and Pb; the group VB elements such as As, Sb, and Bi; the group VIB elements such as Te and Po; the lanthanide series elements such as La, Ce, Pr, and Nd; the actinium series elements such as Ac, Th, and U; and the like.

Examples of inorganic compounds include hydrogen compound, hydroxide, nitride, halide, oxide, carbonate, sulfate, nitrate, metal complex, sulfide, carbide, phosphorus compound, and the like. The inorganic compounds may be composite compounds and examples include oxynitride, composite oxide, and the like.

Among the inorganic substances, inorganic compounds are preferable and particularly preferable examples include oxide, composite oxide, carbonate, sulfate, and the like.

Examples of oxides include metal oxide, with titanium oxides (titanium dioxide, titanium(IV) oxide, and titania: TiO₂) and cerium oxides (cerium dioxide, cerium(IV) oxide, and ceria: CeO₂) being preferable.

Oxides may be used singly or as a combination of two or more.

The composite oxides are compounds of oxygen and a plurality of elements, and the plurality of elements may be a combination of at least two elements selected from the elements other than oxygen present in the aforementioned oxides, the group I elements, and the group II elements.

Examples of the group I elements include alkali metals such as Li, Na, K, Rb, and Cs. Examples of the group II elements include alkaline earth metals such as Be, Mg, Ca, Sr, Ba, and Ra.

Preferable examples of combinations of elements include a combination of a group II element and a group IVB element, a combination of a group II element and a group VIII element, a combination of a group II element and a group WA element, and other combinations that contain at least a group II element.

Examples of composite oxides containing at least a group II element include alkaline earth metal titanates, alkaline earth metal zirconates, alkaline earth metal ferrates, alkaline earth metal stannates, and the like.

A preferable composite oxide may be an alkaline earth metal titanate.

Examples of alkaline earth metal titanates include beryllium titanate (BeTiO₃), magnesium titanate (MgTiO₃), calcium titanate (CaTiO₃), strontium titanate (SrTiO₃), barium titanate (BaTiO₃), radium titanate (RaTiO₃), and the like.

Composite oxides may be used singly or as a combination of two or more.

As for carbonates, examples of elements that combine with carbonic acid include alkali metals, alkaline earth metals, and the like. Examples of alkali metals and alkaline earth metals are as described above.

Among the elements that combine with carbonic acid, alkaline earth metals are preferable.

Specifically, preferable carbonates include those containing alkaline earth metals, and examples of such carbonates include beryllium carbonate, magnesium carbonate, calcium carbonate, strontium carbonate, barium carbonate, radium carbonate, and the like. Carbonates may be used singly or as a combination of two or more.

Sulfates are compounds of sulfate ions (SO₄²⁻) and metal cations (more specifically, compounds formed by the substitution of hydrogen atoms of sulfuric acid (H₂SO₄) with a metal), and examples of metals contained in sulfates include alkali metals, alkaline earth metals, and the like. Examples of alkali metals and alkaline earth metals are as described above.

Among the metals, alkaline earth metals are preferable.

Specifically, preferable sulfates include those containing alkaline earth metals, and examples of such sulfates include beryllium sulfate, magnesium sulfate, calcium sulfate, strontium sulfate, barium sulfate, radium sulfate, and the like, with barium sulfate being preferable.

Sulfates may be used singly or as a combination of two or more.

The plurality of organic compounds (starting organic materials) are, for example, mutually different organic group-introducing compounds for introducing (distributing) mutually different organic groups onto the surface of inorganic particles. Specifically, the organic compounds contain mutually different organic groups and a linker that can be bonded to the surface of inorganic particles.

The linker may be suitably selected according to the type of inorganic particle, and examples include functional groups (first functional group, binding functional group) such as a carboxyl group, a phosphate group (—PO(OH)₂, phosphono group), an amino group, a sulfo group, a hydroxyl group, a thiol group, an epoxy group, an isocyanate group (cyano group), a nitro group, an azo group, a silyloxy group, an imino group, an aldehyde group (acyl group), a nitrile group, a vinyl group (polymerizable group), and the like. Preferable examples include a carboxyl group, a phosphate group, an amino group, a sulfo group, a hydroxyl group, a thiol group, an epoxy group, an azo group, a vinyl group, and the like, with a carboxyl group and a phosphate group being particularly preferable.

The carboxyl group includes its esters. To be specific, the carboxyl group includes alkoxy carbonyl (carboxylic acid alkyl ester) such as ethoxy carbonyl (carboxylic acid ethylester) and the like.

The phosphate group includes its esters. For example, the phosphate group includes dialkoxy phosphonyl groups (phosphoric acid dialkyl ester) such as diethoxy phosphonyl (phosphoric acid diethylester) and the like.

The linker is selected appropriately in accordance with the above-described inorganic particles. To be specific, when the inorganic particles are composed of cerium oxide or strontium carbonate, for example, a carboxyl group is selected, and when the inorganic particles are composed of titanium oxide, for example, a phosphate group is selected.

One or more of these linkers are contained in each organic compound. In particular, a linker is bonded to a terminal or a side chain of an organic group.

Examples of the plurality of mutually different organic groups include organic groups each having a different number of main-chain atoms and/or organic groups each having a different main-chain molecular structure. Specific examples of the plurality of organic groups include hydrocarbon groups each having a different number of main-chain carbon atoms and/or hydrocarbon groups each having a different main-chain molecular structure.

Examples of such hydrocarbon groups include aliphatic groups, alicyclic groups, araliphatic groups (these are also called as aralkyl groups), aromatic groups, and the like.

Examples of aliphatic groups include saturated aliphatic groups, unsaturated aliphatic groups, and the like.

Examples of saturated aliphatic groups include alkyl groups having 1 to 30 carbon atoms and the like.

Examples of alkyl groups include linear or branched alkyl groups (paraffin hydrocarbon groups) having 1 to 30 carbon atoms such as methyl, ethyl, propyl, isopropyl, butyl, isobutyl, sec-butyl, t-butyl, pentyl, isopentyl, neopentyl, hexyl, heptyl, octyl, 2-ethylhexyl, 3,3,5-trimethylhexyl, isooctyl, nonyl, isononyl, decyl, 2-hexyldecyl, isodecyl, undecyl, dodecyl, tridecyl, tetradecyl, pentadecyl, hexadecyl, heptadecyl, octadecyl, nonadecyl, icosyl, icosyl (arachidyl), and triacontyl (melissyl). Linear alkyl groups having 4 to 30 carbon atoms are preferable.

Examples of unsaturated aliphatic groups include alkenyl groups and alkynyl groups having 2 to 20 carbon atoms and similar groups.

Examples of alkenyl groups include alkenyl groups (olefin hydrocarbon groups) having 2 to 20 carbon atoms such as ethenyl, propenyl, butenyl, pentenyl, hexenyl, octenyl, nonenyl, decenyl, undecenyl, dodecenyl, tetradecenyl, hexadecenyl, octadecenyl (oleyl), icosenyl, octadeca-dienyl, and octadeca-trienyl.

Examples of alkynyl groups include alkynyl groups (acetylene hydrocarbon groups) having 2 to 20 carbon atoms such as ethynyl, propynyl, butynyl, pentynyl, hexynyl, heptynyl, octynyl, deeply', undecynyl, dodecynyl, tridecynyl, tetradecynyl, pentadecynyl, hexadecynyl, heptadecynyl, and octadecynyl.

Examples of alicyclic groups include cycloalkyl groups having 4 to 20 carbon atoms; cycloalkenylalkylene groups having 7 to 20 carbon atoms such as norbornenyl; and the like.

Examples of cycloalkyl groups include cyclobutyl, cyclopentyl, cyclohexyl, cycloheptyl, cyclooctyl, cyclononyl, cyclodecyl, cycloundecyl, cyclododecyl, cyclohexylpropyl, cyclohexylpentyl, propylcyclohexyl, dicyclohexylethyl, cyclohexyldecyl, and the like.

Examples of cycloalkenylalkylene groups include norbornene decyl (norboneryl decyl, bicyclo[2.2.1]hept-2-enyl-decyl) and the like.

Examples of araliphatic groups include aralkyl groups having 7 to 20 carbon atoms such as benzyl, phenylethyl, phenylpropyl, phenylbutyl, phenylpentyl, phenylhexyl, phenylheptyl, diphenylmethyl, diphenylpropyl, biphenylethyl, and naphthaleneethyl.

Examples of aromatic groups include aryl groups having 6 to 20 carbon atoms such as phenyl, xylyl, naphthyl, and biphenyl.

Specific examples of the organic compound (first organic compound) containing the aforementioned organic groups (a linker group and a hydrocarbon group in particular) include aliphatic group-containing carboxylic acids (fatty acids) such as saturated aliphatic group-containing carboxylic acids (saturated fatty acids), e.g., acetic acid, propionic acid, ethylhexanoic acid, hexadecanoic acid, timethylhexanoic acid, hexanoic acid, decanoic acid, arachidic acid, melissic acid, and triacontynoic acid; unsaturated aliphatic group-containing carboxylic acids (unsaturated fatty acids), e.g., undecenoic acid, oleic acid, linolic acid, and linolenic acid; and the like. Moreover, other examples of the first organic compound include alicyclic group-containing carboxylic acids (alicyclic carboxylic acids) such as cyclohexylcarboxylic acid, cyclohexylpropionic acid, cyclohexylpentanoic acid, propylcyclohexylcarboxylic acid, dicyclohexylacetic acid, ethylhexanoic acid, and trimethylhexanoic acid; araliphatic group-containing carboxylic acids (araliphatic carboxylic acids) such as 6-phenylhexanoic acid, diphenylpropionic acid, biphenylacetic acid, and naphthaleneacetic acid; aromatic group-containing carboxylic acids (aromatic carboxylic acids) such as benzoic acid and toluenecarboxylic acid; and the like. Still other examples may be aliphatic group-containing phosphonic acids such as methylphosphonic acid; aliphatic group-containing phosphonic acid esters such as diethyl decylphosphonate, and diethyl octylphosphonate; and the like.

Regarding the plurality of organic groups, at least one of the organic groups is a functional group-containing organic group at least containing a functional group (second functional group) in a side chain or at a terminal, and when two or more of the organic groups are functional group-containing organic groups, the organic groups each have a different functional group or a different number of main-chain atoms.

Preferably, regarding the plurality of organic groups, at least one of the organic groups is a functional group-containing hydrocarbon-based organic group at least containing a hydrocarbon group and a functional group bonded to the hydrocarbon group, and when two or more of the organic groups are functional group-containing hydrocarbon-based organic groups, the organic groups each have a different functional group or a different number of main-chain carbon atoms.

The hydrocarbon group contained in a functional group-containing hydrocarbon-based organic group may be the same as those described above.

The functional group-containing hydrocarbon-based organic group has a foregoing hydrocarbon group and a functional group bonded thereto (active functional group, second functional group).

That is, the functional group is regarded as an active group for activating the surface of inorganic particles and, in the organic compounds, is bonded to a terminal (the terminal (second terminal) opposite the terminal to which the linker is bonded (first terminal)) or a side chain of the hydrocarbon group. Therefore, the functional group can also be used as an active group for activating the surface of inorganic composite particles.

Examples of the functional group (second functional group) include a carboxyl group, a hydroxyl group, a phosphate group (—PO(OH)₂, phosphono group), a thiol group, an amino group, a sulfo group, a carbonyl group, an epoxy group, an isocyanate group, a nitro group, an azo group, a silyloxy group, an imino group, an acyl group, an aldehyde group, a cyano group, a nitrile group, a vinyl group (polymerizable group), a halogen group (e.g., bromo), and the like. Preferable examples of the functional group include a carboxyl group, a phosphate group, an amino group, a sulfo group, a hydroxyl group, a thiol group, an epoxy group, an azo group, an amino group, a carbonyl group, a vinyl group, and the like.

One or more of these functional groups may be contained in each organic compound.

Examples of functional group-containing hydrocarbon-based organic groups include carboxyl group-containing organic groups, hydroxyl group-containing organic groups, phosphate group-containing organic groups, thiol group-containing organic groups, amino group-containing organic groups, sulfo group-containing organic groups, carbonyl group-containing organic groups, and the like.

Examples of carboxyl group-containing organic groups include carboxyaliphatic groups such as carboxysaturated aliphatic groups including 2-carboxyethyl, 3-carboxypropyl, 4-carboxybutyl, 5-carboxypentyl, 6-carboxyhexyl, 7-carboxyheptyl, 8-carboxyoctyl, 9-carboxynonyl, and 10-carboxydecyl; carboxyunsaturated aliphatic groups including carboxybutenyl; and the like. Other examples of carboxyl group-containing organic groups include carboxyalicyclic groups including carboxycyclohexyl; carboxyaraliphatic groups including carboxyphenylpropyl, carboxyphenylhexyl, carboxyhexylphenyl, carboxyphenyloctyl, carboxyphenyldecyl, carboxyphenylethyl, and carboxyphenylpropyl; carboxyaromatic groups including carboxyphenyl; and the like.

Examples of carboxyl group-containing organic groups also include alkoxycarbonyl aliphatic groups including alkoxycarbonyl saturated aliphatic groups such as 3-(ethoxy-carbonyl)propyl, 6-(ethoxy-carbonyl)hexyl, 10-(ethoxy-carbonyl)decyl, and the like.

Examples of hydroxyl group-containing organic groups include hydroxysaturated aliphatic groups (hydroxyaliphatic groups) including 4-hydroxybutyl, 6-hydroxyhexyl, 8-hydroxyoctyl, and 10-hydroxydecyl; hydroxyaraliphatic groups including 4-hydroxybenzyl, 2-(4-hydroxyphenyl)ethyl, 3-(4-hydroxyphenyl)propyl, and 6-(4-hydroxyphenyl)hexyl; hydroxyaromatic groups including hydroxyphenyl; and the like.

Examples of phosphate group-containing organic groups include phosphonosaturated aliphatic groups (phosphonoaliphatic groups) including 3-phosphonopropyl and 6-phosphonohexyl; phosphonoaraliphatic groups including 6-phosphonophenylhexyl; and the like.

Examples of phosphate group-containing organic groups also include dialkoxy phosphonyl aliphatic groups (phosphoric acid dialkyl ester groups) such as 3-(diethoxy-phosphonyl)propyl, 6-(diethoxy-phosphonyl)hexyl, 10-(diethoxy-phosphonyl)decyl, and the like.

Examples of thiol group-containing organic groups include mercaptosaturated aliphatic groups (mercaptoaliphatic groups) such as 10-mercaptodecyl; and the like.

Examples of amino group-containing organic groups include aminosaturated aliphatic groups (aminoaliphatic groups) such as 6-aminohexyl; aminoaraliphatic groups such as 6-aminophenylhexyl; and the like.

Examples of sulfo group-containing organic groups include sulphosaturated aliphatic groups (sulphoaliphatic groups) such as 6-sulphohexyl; sulphoaraliphatic groups such as 6-sulphophenylhexyl; and the like.

Examples of carbonyl group-containing organic groups include oxosaturated aliphatic groups (oxoaliphatic groups) such as 4-oxopentyl, 5-oxohexyl, and 7-oxooctyl; and the like.

Specifically, the second organic compound is an organic compound that contains a foregoing functional group-containing hydrocarbon-based organic group, and examples include hydrophilizing organic compounds including carboxyl group-containing organic compound, hydroxyl group-containing organic compound, phosphate group-containing organic compound, thiol group-containing organic compound, amino group-containing organic compound, sulfo group-containing organic compound, carbonyl group-containing organic compound, and the like.

Examples of carboxyl group-containing organic compounds include, when both of the linker (first functional group) and the functional group (second functional group) are carboxyl groups, dicarboxylic acid and the like. Examples of such dicarboxylic acids include saturated aliphatic dicarboxylic acid such as propanedioic acid (malonic acid), butanedioic acid (succinic acid), hexanedioic acid (adipic acid), octanedioic acid, and decanedioic acid (sebacic acid); unsaturated aliphatic dicarboxylic acid such as itaconic acid; alicyclic dicarboxylic acid such as cyclohexyl dicarboxylic acid; araliphatic dicarboxylic acid such as carboxyphenylpropionic acid and 6-carboxyphenyl hexanoic acid; aromatic dicarboxylic acid such as phthalic acid, terephthalic acid, and isophthalic acid; and the like.

Examples of carboxyl group-containing organic compounds also include, when the linker (first functional group) is a phosphate group and the functional group (second functional group) is a carboxyl group (to be more specific, when a phosphate group is bonded to inorganic particles composed of titanium oxide), and/or when the linker (first functional group) is a carboxyl group and the functional group (second functional group) is a phosphate group (to be more specific, when a carboxyl group is bonded to inorganic particles composed of cerium oxide or strontium carbonate), a compound having both of a phosphate group and a carboxyl group including monophosphonocarboxylic acid such as 3-phosphonopropionic acid, 6-phosphono hexanoic acid, 8-phosphono octanoic acid, 10-phosphono decanoic acid, and 6-phosphonophenyl hexanoic acid; and dialkoxy phosphonyl carboxylic acid alkyl ester such as 3-(diethoxy-phosphonyl) propionic acid ethylester, 6-(diethoxy-phosphonyl) hexanoic acid ethylester, 8-(diethoxy-phosphonyl) octanoic acid ethylester, and 10-(diethoxy-phosphonyl) decanoic acid ethylester. The above-described compound having both of a phosphate group and a carboxyl group is also a phosphate group-containing organic compound.

Examples of hydroxyl group-containing organic compounds include, when the linker (first functional group) is a carboxyl group and the functional group (second functional group) is a hydroxyl group, for example, monohydroxycarboxylic acid, and examples of such monohydroxycarboxylic acid include, to be specific, 4-hydroxybutanoic acid, 6-hydroxy hexanoic acid, 8-hydroxyoctanoic acid, 10-hydroxydecanoic acid, 4-hydroxyphenylacetic acid, 3-(4-hydroxyphenyl)propionic acid, 6-(4-hydroxyphenyl) hexanoic acid (6-(4-hydroxyphenyl)caproic acid), hydroxyphenyl hexanoic acid, carboxyhexyloxybenzoic acid, hydroxybenzoic acid, and hydroxyphenylacetic acid. Examples of hydroxyl group-containing organic compound also include 6-hydroxy hexanoic acid ethylester (ethyl 6-hydroxyhexanoate) and the like.

Examples of thiol gorup-containing organic compounds include, when the linker (first functional group) is a carboxyl group and the functional group (second functional group) is a thiol group, 10-carboxydecanethiol and the like.

Examples of amino group-containing organic compounds include, when the linker (first functional group) is a carboxyl group and the functional group (second functional group) is an amino group, monoaminocarboxylic acid, and specific examples include 6-aminohexanoic acid, 6-aminophenylhexanoic acid, and the like.

Examples of sulfo group-containing organic compounds include, when the linker (first functional group) is a carboxyl group and the functional group (second functional group) is a sulfo group, monosulfocarboxylic acid, and specific examples include 6-sulfohexanoic acid, 6-sulfophenylhexanoic acid, and the like.

Examples of carbonyl group-containing organic compounds include, when the linker (first functional group) is a carboxyl group and the functional group (second functional group) is a carbonyl group, monocarbonylcarboxylic acid, and specific examples include 4-oxopentanoic acid (4-oxovaleric acid), 5-oxohexanoic acid (5-oxocaproic acid), and the like.

In the plurality of organic compounds, the organic groups are mutually different.

The plurality of organic groups are, for example, hydrocarbon groups each having a different number of main-chain carbon atoms. An example of such a combination may be a combination of at least two hydrocarbon groups selected from the group consisting of aliphatic groups, alicyclic groups, araliphatic groups, and aromatic groups each having a different number of carbon atoms (first combination). Preferable may be a combination of hexyl and decyl, a combination of hexyl and ethylhexyl, a combination of phenyl and 6-phenylhexyl, a combination of propylcyclohexyl and cyclohexyl, a combination of decyl and trimethylhexyl, or a like combination.

Among the plurality of organic groups, at least one organic group may be a foregoing functional group-containing hydrocarbon-based organic group.

In this case, the plurality of organic groups are, for example, a combination of at least one hydrocarbon group and at least one functional group-containing hydrocarbon-based organic group (second combination) or a combination of at least two functional group-containing hydrocarbon-based organic groups (third combination).

As for the second combination, the combination of at least two groups may be, for example, a combination of an aliphatic group and a hydroxyaliphatic group, a combination of an aliphatic group and a carboxy aliphatic group, a combination of an aliphatic group and an oxoaliphatic group, a combination of an aliphatic group and a mercapto aliphatic group, and the like. In the second combination, the number of carbon atoms is not particularly limited, and examples thereof include a combination of a hydrocarbon group and a functional group-containing hydrocarbon organic group having mutually different numbers of carbon atoms (to be specific, a combination of an aliphatic group having 1 to 9 carbon atoms and a functional group-containing hydrocarbon organic group having 10 to 20 carbon atoms).

Examples of the combination of an aliphatic group and a hydroxyaliphatic group may be a combination of decyl and 6-hydroxyhexyl, and a combination of hexyl and 6-hydroxyhexyl.

Examples of the combination of an aliphatic group and a carboxy aliphatic group include a combination of methyl and 3-carboxypropyl, a combination of methyl and 6-carboxyhexyl, a combination of methyl and 10-carboxydecyl, a combination of hexyl and 10-carboxydecyl, and the like. Examples of the combination of an aliphatic group and a carboxy aliphatic group also include a combination of an aliphatic group and an alkoxycarbonyl aliphatic group such as a combination of methyl and 10-(ethoxy-carbonyl)decyl, a combination of octyl and 10-(ethoxy-carbonyl)decyl, a combination of decyl and 10-(ethoxy-carbonyl)decyl, a combination of methyl, decyl, and 10-(ethoxy-carbonyl)decyl, a combination of octyl, decyl, and 10-(ethoxy-carbonyl)decyl, and the like.

Examples of the combination of an aliphatic group and an oxoaliphatic group include a combination of propyl and 4-oxopentyl, a combination of hexyl and 7-oxooctyl, and the like.

Examples of the combination of an aliphatic group and a mercapto aliphatic group include a combination of hexyl and 10-carboxydecanethiol and the like.

As for the third combination, in the at least two (i.e., two or more) functional group-containing organic groups, the functional groups are different to each other. As for the third combination, an example of the combination of the at least two functional group-containing organic groups may be a combination of two functional group-containing hydrocarbon-based organic groups selected from the group consisting of carboxyl group-containing organic groups, hydroxyl group-containing organic groups, phosphate group-containing organic groups, thiol group-containing organic groups, amino group-containing organic groups, sulfo group-containing organic groups, and carbonyl group-containing organic groups. A combination of a hydroxyaliphatic group and an oxoaliphatic group, a combination of a carboxy aliphatic group and an alkoxycarbonyl aliphatic group, a combination of carboxy aliphatic groups having mutually different numbers of carbon atoms, and a combination of alkoxycarbonyl aliphatic groups having mutually different numbers of carbon atoms are preferable.

An example of the combination of a hydroxyaliphatic group and an oxoaliphatic group may be a combination of 6-hydroxyhexyl and 5-oxohexyl.

An example of the combination of a carboxy aliphatic group and an alkoxycarbonyl aliphatic group may be a combination of 3-carboxypropyl and 10-(ethoxy-carbonyl)decyl.

Examples of the combination of carboxy aliphatic groups having mutually different numbers of carbon atoms include a combination of a carboxy aliphatic group having carbon atoms of less than 6 and a carboxy aliphatic group having carbon atoms of 6 or more, to be specific, a combination of 3-carboxypropyl and 6-carboxyhexyl.

Examples of the combination of alkoxycarbonyl aliphatic groups having mutually different numbers of carbon atoms include a combination of an alkoxycarbonyl aliphatic group having carbon atoms of less than 6 and an alkoxycarbonyl aliphatic group having carbon atoms of 6 or more, to be specific, a combination of 3-(ethoxy-carbonyl)propyl and 6-(ethoxy-carbonyl)hexyl.

The plurality of mutually different organic groups are present on the surface of common inorganic particles in the organic-inorganic composite particles. That is, the mutually different organic groups coat the surface of the same inorganic particles. Specifically, the mutually different organic groups stretch outward from the surface of the common inorganic particles via a linker.

The organic-inorganic composite particles can be obtained by subjecting an inorganic substance and a plurality of mutually different organic compounds to a reaction treatment, preferably a high-temperature treatment.

The organic-inorganic composite particles are produced by subjecting an inorganic substance and a plurality of mutually different organic compounds to a reaction treatment, preferably a high-temperature treatment.

The high-temperature treatment is carried out in a solvent. Examples of solvents include water and the aforementioned organic compounds.

Specifically, an inorganic substance and a plurality of mutually different organic compounds are subjected to a high-temperature treatment in water under high pressures (hydrothermal synthesis: hydrothermal reaction) or an inorganic substance is subjected to a high-temperature treatment in a plurality of mutually different organic compounds (a high-temperature treatment in a plurality of mutually different organic compounds) to give organic-inorganic composite particles. That is, the surface of inorganic particles formed of an inorganic substance is treated with a plurality of mutually different organic compounds to give organic-inorganic composite particles.

For example, in a hydrothermal synthesis, an inorganic substance and a plurality of mutually different organic compounds are reacted under high-temperature, high-pressure conditions in the presence of water (first hydrothermal synthesis).

The inorganic substance subjected to the first hydrothermal synthesis is preferably a carbonate or a sulfate.

The mutually different organic compounds correspond to the mutually different organic groups described above. Specifically, the plurality of mutually different organic compounds contain a plurality of mutually different organic groups corresponding to the above-described first, second, or third combination.

As for the proportions of respective ingredients, the total proportion of the plurality of organic compounds is, for example, 1 to 1500 parts by mass, preferably 5 to 500 parts by mass, and more preferably 5 to 250 parts by mass, and the proportion of water is, for example, 50 to 8000 parts by mass, preferably 80 to 6600 parts by mass, and more preferably 100 to 4500 parts by mass, per 100 parts by mass of inorganic substance.

Since the density of the plurality of organic compounds is normally 0.8 to 1.1 g/mL, the total proportion of the plurality of organic compounds is, for example, 0.9 to 1880 mL, preferably 4.5 to 630 mL, and more preferably 4.5 to 320 mL, per 100 g of inorganic substance.

The total molar proportion of the plurality of organic compounds is, for example, 0.01 to 1000 mol, preferably 0.02 to 50 mol, and more preferably 0.1 to 10 mol, per one mol of inorganic substance.

As for the total proportion of the plurality of organic compounds, when a plurality of (e.g., two) different organic groups are contained, specifically, the proportion of one organic compound relative to the other organic compound in terms of mass, volume, and mole is, in all cases, for example, 1:99 to 99:1 and preferably 10:90 to 90:10.

More specifically, when the plurality of mutually different organic groups are of the first combination, for example, when the plurality of mutually different organic compounds each have a different number of carbon atoms, the proportion of one organic compound having fewer carbon atoms to the other organic compound having more carbon atoms in terms of mass, volume, and mole is, in all cases, for example, 10:90 to 99.9:0.1 and preferably 20:80 to 99:1.

When the plurality of mutually different organic groups are of the second combination, for example, when the plurality of mutually different organic compounds are a combination of the first organic compound and the second organic compound, the proportion of the first organic compound to the second organic compound in terms of mass, volume, and mole is, in all cases, for example, 1:99 to 99:1 and preferably 10:90 to 90:10.

When the plurality of organic groups are of the third combination, for example, when the plurality of organic compounds are a combination of a hydroxyaliphatic acid and an oxoaliphatic acid each having a different number of carbon atoms, the proportion of the hydroxyaliphatic acid to the oxoaliphatic acid in terms of mass, volume, and mole is, in all cases, for example, 1:99 to 99:1 and preferably 10:90 to 90:10.

Since the density of water is normally about 1 g/mL, the proportion of water is, for example, 50 to 8000 mL, preferably 80 to 6600 mL, and more preferably 100 to 4500 mL, per 100 g of inorganic compound.

Specifically, as for the reaction conditions in a hydrothermal reaction, the heating temperature is, for example, 100 to 500° C. and preferably 200 to 400° C. The pressure is, for example, 0.2 to 50 MPa, preferably 1 to 50 MPa, and more preferably 10 to 50 MPa. The reaction time is, for example, 1 to 200 minutes and preferably 3 to 150 minutes. Meanwhile, when a continuous reactor is used, the reaction time may be 1 minute or less.

The reaction products obtained after the reaction mainly include a precipitate mostly precipitating in water and a deposit adhering to the inner wall of an airtight container.

The precipitate is obtained by, for example, sedimentation separation in which the reaction products are subjected to gravity or a centrifugal field to settle the precipitate. Preferably, the precipitate is obtained as the precipitate of the reaction products by centrifugal sedimentation (centrifugal separation) in which settling takes place in a centrifugal field.

The deposit is collected with, for example, a spatula or the like.

It is also possible that a solvent is added to the reaction products to wash away the unreacted organic compounds (that is, organic compounds are dissolved in a solvent) and then the solvent is removed and the reaction products are recovered (isolated).

Examples of solvents include alcohols (hydroxyl group-containing aliphatic hydrocarbons) such as methanol, ethanol, propanol, and isopropanol; ketones (carbonyl group-containing aliphatic hydrocarbons) such as acetone, methyl ethyl ketone, cyclohexanone, and cyclopentanone; aliphatic hydrocarbons such as pentane, hexane, and heptane; halogenated aliphatic hydrocarbons such as dichloromethane, chloroform, and trichloroethane; halogenated aromatic hydrocarbons such as chlorobenzene and dichlorobenzene; ethers such as tetrahydrofuran; aromatic hydrocarbons such as benzene, toluene, and xylene; aqueous pH controlling solutions such as aqueous ammonia; and the like. Alcohols are preferable.

The reaction products after washing are isolated from the solvent (supernatant) by, for example, filtration, decantation, or a similar technique, and then recovered. Thereafter, the reaction products may be dried if necessary by, for example, heating or in an air stream.

In this manner, organic-inorganic composite particles having a plurality of mutually different organic groups on the surface of inorganic particles are obtained.

In the first hydrothermal synthesis, the pre-reaction inorganic substance and the post-reaction inorganic substance that forms inorganic particles are the same.

Alternatively, by subjecting an inorganic substance (starting material) and a plurality of mutually different organic compounds to a hydrothermal synthesis, it is also possible to obtain organic-inorganic composite particles containing inorganic particles formed of an inorganic substance that is different from the starting inorganic substance (second hydrothermal synthesis).

Examples of the inorganic substance subjected to the second hydrothermal synthesis include hydroxides, metal complexes, nitrates, sulfates, and the like. Hydroxides and metal complexes are preferable.

Examples of the elements contained in the hydroxides (elements that serve as cations and combine with the hydroxyl ion (Off)) include the same elements that combine with oxygen in the above-described oxides.

Specific examples of hydroxides may be titanium hydroxide (Ti(OH)₄) and cerium hydroxide (Ce(OH)₄).

The metallic elements contained in the metal complexes are those that form composite oxides with the metals contained in the above-described hydroxides, and examples include titanium, iron, tin, zirconium, and the like. Titanium is preferable.

Examples of ligands in the metal complexes include monohydroxycarboxylic acids such as 2-hydroxyoctanoic acid; and the like.

Examples of metal complexes include 2-hydroxyoctanoic acid titanate and the like. The metal complexes can be obtained from the aforementioned metallic elements and ligands.

Examples of the plurality of mutually different organic compounds include a plurality of mutually different organic compounds as used for the first hydrothermal synthesis.

In the second hydrothermal synthesis, an inorganic substance and a plurality of mutually different organic compounds are reacted under high-temperature, high-pressure conditions in the presence of water.

As for the proportions of respective ingredients, the proportion of the plurality of mutually different organic compounds is, for example, 1 to 1500 parts by mass, preferably 5 to 500 parts by mass, and more preferably 5 to 250 parts by mass, and the proportion of water is, for example, 50 to 8000 parts by mass, preferably 80 to 6600 parts by mass, and more preferably 80 to 4500 parts by mass, per 100 parts by mass of inorganic compound.

The total proportion of the plurality of mutually different organic compounds is, for example, 0.9 to 1880 mL, preferably 4.5 to 630 mL, and more preferably 4.5 to 320 mL, per 100 g of hydroxide. The total molar proportion of the plurality of mutually different organic compounds is, for example, 0.01 to 10000 mol and preferably 0.1 to 10 mol per one mol of hydroxide.

The proportion of water is, for example, 50 to 8000 mL, preferably 80 to 6600 mL, and more preferably 100 to 4500 mL, per 100 g of hydroxide.

The reaction conditions in the second hydrothermal synthesis are the same as the reaction conditions in the first hydrothermal synthesis described above.

In this manner, organic-inorganic composite particles having a plurality of mutually different organic groups on the surface of inorganic particles formed of an inorganic substance that is different from the starting inorganic substance are obtained.

The formulation used for the second hydrothermal synthesis may further include, in addition to the aforementioned ingredients, a carbonic acid source or a hydrogen source.

Examples of carbonic acid sources include carbon dioxide (carbon dioxide gas), formic acid and/or urea.

Examples of hydrogen sources include hydrogen (hydrogen gas); acids such as formic acid and lactic acid; hydrocarbons such as methane and ethane; and the like.

The proportion of carbonic acid source or hydrogen source is, for example, 5 to 140 parts by mass and preferably 10 to 70 parts by mass per 100 parts by mass of inorganic substance.

Alternatively, the proportion of carbonic acid source is, for example, 5 to 100 mL and preferably 10 to 50 mL per 100 g of inorganic substance. The molar proportion of carbonic acid source is, for example, 0.4 to 100 mol, preferably 1.01 to 10.0 mol, and more preferably 1.05 to 1.30 mol, per one mol of inorganic substance.

Alternatively, the proportion of hydrogen source is, for example, 5 to 100 mL and preferably 10 to 50 mL per 100 g of inorganic substance. The molar proportion of hydrogen source is, for example, 0.4 to 100 mol, preferably 1.01 to 10.0 mol, and more preferably 1.05 to 2.0 mol per one mol of inorganic substance.

In the high-temperature treatment performed in the plurality of mutually different organic compounds, the inorganic substance and the plurality of mutually different organic compounds are blended and heated, for example, under ordinary pressures. While being subjected to the high-temperature treatment, the plurality of mutually different organic compounds serve as organic group-introducing compounds as well as a solvent for dispersing or dissolving the inorganic substance.

The total proportion of the mutually different organic compounds is, for example, 10 to 10000 parts by mass and preferably 100 to 1000 parts by mass per 100 parts by mass of inorganic substance. In terms of volume, the total proportion of the mutually different organic compounds is, for example, 10 to 10000 mL and preferably 100 to 1000 mL per 100 g of inorganic substance.

The heating temperature is, for example, greater than 100° C., preferably 125° C. or greater, and more preferably 150° C. or greater, and usually 300° C. or less and preferably 275° C. or less. The heating time is, for example, 1 to 60 minutes and preferably 3 to 30 minutes.

The shape of the organic-inorganic composite particles (primary particles) obtained in this manner is not particularly limited and is, for example, anisotropic or isotropic, and the average particle diameter thereof (maximum length when anisotropic) is, for example, 200 μm or less, preferably 1 nm to 200 μm, more preferably 3 nm to 50 μm, and particularly preferably 3 nm to 10 μm.

As described in detail in the examples below, the average particle diameter of the organic-inorganic composite particles may be determined by dynamic light scattering (DLS) and/or calculated from a transmission electron microscopic (TEM) or scanning electron microscopic (SEM) image analysis.

When the average particle diameter is lower than the aforementioned range, the proportion of the volume of the mutually different organic groups relative to the surface of the organic-inorganic composite particles is high, and the function of the inorganic particles is unlikely to be ensured.

When the average particle diameter exceeds the aforementioned range, particles may be crushed when being blended with the resin.

The organic-inorganic composite particles obtained in this manner are unlikely to agglomerate in a dry state, and even when the particles appear to be agglomerated in a dry state, agglomeration (formation of secondary particles) is inhibited in a particle-dispersed resin composition as well as in a particle-dispersed resin article, and the particles are dispersed nearly uniformly as primary particles in the resin.

In the organic-inorganic composite particles, the proportion of the surface area of the organic groups relative to the surface area of the inorganic particles, i.e., the surface coverage by the organic groups in the organic-inorganic composite particles (=(surface area of organic group/surface area of inorganic particle)×100) is usually, for example, 30% or greater and preferably 60% or greater, and usually 200% or less.

In the calculation of surface coverage, first, the shape of the inorganic particles is determined by transmission electron microscopy (TEM), the average particle diameter is then calculated, and the specific surface area of the particles is calculated from the shape of the inorganic particles and the average particle diameter. Alternatively, the proportion of the organic groups accounting for the organic-inorganic composite particles may be calculated from the weight change resulting from heating the organic-inorganic composite particles to 800° C. using a differential thermal balance (TG-DTA); the amount of the organic groups per particle is then calculated from the molecular weight of the organic groups, the particle density, and the average volume; and the surface coverage is determined from these factors.

When at least the surface coverage is high and the organic groups of the organic-inorganic composite particles have a length sufficient to cancel the electric charge of the inorganic particles, the kind of solvent (medium) for dispersing the organic-inorganic composite particles may be selected (specified or managed) according to the kind of organic group.

The organic-inorganic composite particles obtained above may be subjected to wet classification.

That is, a solvent is added to the organic-inorganic composite particles, and the mixture is stirred, left to stand still, and then separated into supernatant and precipitate. The solvent may be the same as those described above, and halogenated aliphatic hydrocarbons are preferable.

Subsequently, the supernatant is recovered and it is thus possible to obtain organic-inorganic composite particles having a small particle diameter.

Wet classification allows the average maximum length of the resulting organic-inorganic composite particles (primary particles) to be controlled so as to be, for example, 3 nm to 450 nm, preferably 3 nm to 200 nm, and more preferably 3 nm to 100 nm.

The solvent for dispersing the particles obtained above is not particularly limited and examples include those usable in the above-described washing. In addition to those solvents, other examples include alicyclic hydrocarbons such as cyclopentane and cyclohexane; esters such as ethyl acetate; polyols such as ethylene glycol and glycerol; nitrogen-containing compounds such as N-methylpyrrolidone, pyridine, acetonitrile, and dimethylformamide; acryl-based monomers such as isostearyl acrylate, lauryl acrylate, isoboronyl acrylate, butyl acrylate, methacrylate, acrylic acid, tetrahydrofurfuryl acrylate, 1,6-hexanediol diacrylate, 2-hydroxyethyl acrylate, 4-hydroxybutyl acrylate, phenoxyethyl acrylate, and acryloylmorpholine; vinyl group-containing monomers such as styrene and ethylene; epoxy-containing compounds such as bisphenol A epoxy; and the like. Aliphatic hydrocarbons, halogenated aliphatic hydrocarbons, aromatic hydrocarbons, and ethers are preferable.

These solvents may be used singly or as a combination of two or more.

The proportion of solvent blended is not particularly limited, and the concentration of organic-inorganic composite particle in the particle dispersion is adjusted so as to be, for example, 0.1 to 99 mass %, preferably 1 to 90 mass %, and more preferably 1 to 80 mass %.

The manner of dispersing particles in a solvent is not particularly limited, and particles and a solvent may be blended and stirred. The organic-inorganic composite particles can be dispersed according to such a simple method. Also, ultrasonication, and other known dispersion treatments such as bead milling may be performed.

Accordingly, in the particle dispersion, the organic-inorganic composite particles are uniformly dispersed as primary particles in a solvent, i.e., without particle agglomeration.

Furthermore, even if dried once, the organic-inorganic composite particles of the present invention can be re-dispersed easily as primary particles when a solvent is added to the organic-inorganic composite particles.

The resin for dispersing the organic-inorganic composite particles is not particularly limited and examples include thermosetting resins and thermoplastic resins.

Examples of thermosetting resins include polycarbonate resin, epoxy resin, thermosetting polyimide resin, phenol resin, urea resin, melamine resin, diallyl phthalate resin, silicone resin, thermosetting urethane resin, and the like.

Examples of thermoplastic resins include olefin resin, acrylic resin, polystyrene resin, polyester resin (in particular, polyarylates and the like), polyacrylonitrile resin, maleimide resin, polyvinyl acetate resin, ethylene-vinylacetate copolymer, polyvinyl alcohol resin, polyamide resin, polyvinyl chloride resin, polyacetal resin, polyphenylene oxide resin, polyphenylene sulfide resin, polysulfone resin, polyether sulfone resin, polyether ether ketone resin, polyallylsulfone resin, thermoplastic polyimide resin, thermoplastic urethane resin, polyetherimide resin, polymethylpentene resin, cellulosic resin, liquid crystal polymer, ionomer, and the like.

These resins may be used singly or as a combination of two or more.

The melting temperature of the resins (in particular, thermoplastic resins) is, for example, 200 to 300° C., and the softening temperature is, for example, 150 to 280° C.

For example, to disperse organic-inorganic composite particles in a resin, at least organic-inorganic composite particles and a resin are blended and stirred.

Preferably, organic-inorganic composite particles, a solvent, and a resin are blended and stirred to give a particle-dispersed resin fluid, and the solvent in the particle-dispersed resin fluid is then removed. Blending a solvent allows the organic-inorganic composite particles to be more uniformly dispersed in the resin.

Specifically, a resin solution dissolved in a solvent and the aforementioned particle dispersion are blended.

Solvents for use in the preparation of a resin solution may be the same as those mentioned above and the proportion of solvent is, for example, 1 to 9900 parts by mass, preferably 40 to 2000 parts by mass, and more preferably 50 to 1000 parts by mass, per 100 parts by mass of the resin of the resin solution.

The resin solution and the particle dispersion is blended such that the proportion of organic-inorganic composite particle is, for example, 0.1 to 9900 parts by mass, preferably 1 to 9000 parts by mass, and more preferably 5 to 400 parts by mass, per 100 parts by mass of resin (solids content). In other words, the concentration of organic-inorganic composite particle in the particle-dispersed resin composition is, for example, 0.1 to 99 mass %, preferably 1 to 90 mass %, and more preferably 1 to 80 mass %.

Meanwhile, to prepare the particle-dispersed resin composition, for example, if the resin is liquefied at ordinary temperatures (or if it is in a liquid state) or if the resin melts when heated, it is also possible that the resin is blended with the organic-inorganic composite particles without a solvent

The particle-dispersed resin composition prepared in this manner is a molten material of the particle-dispersed resin composition that does not contain a solvent

When the resin is composed of a thermoplastic resin, the heating temperature may be the same as the melting temperature of the resin or greater, and specifically the heating temperature is 200 to 350° C. When the resin is composed of a thermosetting resin, the heating temperature may be a temperature at which the state of the resin is at the B stage, for example, 85 to 140° C.

The resin and the organic-inorganic composite particles may be blended such that the concentration of organic-inorganic composite particle is, for example, 0.1 to 80 mass % and preferably 1 to 70 mass %.

The particle-dispersed resin composition as obtained above is then dried by, for example, being heated at 40 to 60° C. to remove the solvent and to give a particle-dispersed resin composition.

The obtained particle-dispersed resin composition is then applied to, for example, a known support so as to prepare a coating, and this coating is dried to be formed into a particle-dispersed resin article that is in a film form.

The particle-dispersed resin composition is applied using, for example, a known application method such as a spin coater method or a bar coater method. Simultaneously with or immediately after the application of the particle-dispersed resin composition, the solvent is removed by volatilization. If necessary, the solvent may be dried by being heated after the application of the resin composition.

The viscosity of the particle-dispersed resin composition during application may be suitably adjusted by, for example, concentrating the resin composition with an evaporator or by drying, or through a similar operation.

The thickness of the film to be obtained is suitably arranged according to the use and the purpose, and the thickness is, for example, 0.1 to 2000 μm, preferably 1 to 1000 μm, and more preferably 5 to 500 μm.

The particle-dispersed resin article can be formed into a film according to a melt process in which the particle-dispersed resin composition is extruded with an extruder.

Also, the particle-dispersed resin composition may be poured into a metal mold or the like and formed into a block (bulk) by, for example, thermoforming with a heat press.

Accordingly, in the particle-dispersed resin article, the organic-inorganic composite particles are uniformly dispersed as primary particles in the resin. That is, the organic-inorganic composite particles do not agglomerate with each other.

The organic-inorganic composite particles of the present invention obtained according to the method described above can be dispersed as primary particles in a solvent and/or a resin in a high proportion, exhibiting excellent dispersibility in a solvent and/or a resin.

Therefore, in the particle dispersion and the particle-dispersed resin composition of the present invention, organic-inorganic composite particles are dispersed highly uniformly. Moreover, the organic-inorganic composite particles can be highly uniformly dispersed therein in a high proportion.

In particular, the plurality of organic groups are different from each other, and thus the intermolecular force between the organic groups and the molecules of the solvent and/or the molecules of the resin is high and compatibility between the organic groups and the molecules of the solvent and/or the molecules of the resin is therefore high.

In detail, when the plurality of organic groups are hydrocarbon groups each having a different number of carbon atoms, the organic groups have different sizes (length and/or scale). Therefore, a space (pocket) is created between the adjacent long-chain and/or bulky homologous organic groups due to the short-chain and/or less bulky organic groups. The molecule of a solvent and/or the molecule of a resin enter into the space, and it is thus possible to enhance interaction between the long-chain and/or bulky homologous organic groups and the molecule of the solvent and/or the molecule of the resin. As a result, the dispersibility of the organic-inorganic composite particles can be enhanced.

When one organic group is a functional group-containing hydrocarbon-based organic group and the other organic group is a hydrocarbon group, since the functional group can be adjusted, it is thus possible to enhance the compatibility of the entire organic groups with the solvent and/or the resin.

Moreover, when the two or more organic groups are functional group-containing hydrocarbon-based organic groups each having a different functional group, since the kind and the amount of functional group can be adjusted, and it is thus possible to enhance the compatibility of the entire two or more organic groups with the solvent and/or the resin.

By adjusting the kind and the amount of functional group, the active site of the organic-inorganic composite particles can also be controlled.

It is thus possible to further enhance the dispersibility of the organic-inorganic composite particles in the solvent and/or the resin.

Therefore, in the particle dispersion and/or the particle-dispersed resin composition of the present invention, the organic-inorganic composite particles are dispersed highly uniformly.

As a result, when the average particle diameter of the organic-inorganic composite particles is less than 400 nm or when the difference in refractive index between the resin and the organic-inorganic composite particles is small, a particle-dispersed resin article formed from the particle-dispersed resin composition can maintain excellent transparency.

Therefore, a particle-dispersed resin article produced as described above has excellent optical properties and is usable in various industrial applications such as optical applications and electromagnetic wave applications.

Moreover, the organic-inorganic composite particles are usable in various applications as filler, coloring, UV blocking, hard coating, crosslinking, dispersant, and catalyst applications.

### EXAMPLES

The present invention shall be described in more detail below by way of examples, comparative examples, preparation examples, and comparative preparation examples. However, the present invention is not limited to these examples.

Organic-inorganic composite particles, particle dispersions, and films (particle-dispersed resin articles) were evaluated according to the following methods.

(1) X-Ray Diffractometry (XRD)

Glass holders were filled with organic-inorganic composite particles and X-ray diffractometry was performed thereon under the following conditions. Thereafter, in reference to the obtained peaks, the components of the inorganic compounds were assigned through database search.

X-ray diffractometer: D8 DISCOVER with GADDS, manufactured by Bruker AXS

### Optical System on Incident Side

X-ray source: CuKα (λ=1.542 Å), 45 kV, 360 mA

Spectroscope (monochromator): multilayer mirror

Collimator diameter: 300 μm

### Optical System on Light-Receiving Side

Counter: two-dimensional PSPC (Hi-STAR)

Distance between organic-inorganic composite particles and counter: 15 cm 2θ=20, 50 or 80 degrees, ω=10, 25, 40 degrees, Phi=0 degrees, Psi=0 degrees

Measurement time: 10 minutes

Assignment (semiquantitation software): FPM EVA, manufactured by Bruker AXS

(2) Fourier Transform Infrared Spectrophotometry (FT-IR)

Fourier transform infrared spectrophotometry was performed on the organic-inorganic composite particles according to the KBr method using the following equipment.

Fourier transform infrared spectrophotometer: FT/1R-470Plus, manufactured by JASCO Corporation.

(3) Determination of Average Particle Diameter and Evaluation of Dispersibility

(a) Average Particle Diameter

Organic-inorganic composite particles were dispersed in a solvent (a good solvent in which the organic-inorganic composite particles were dispersed as primary particles, such as cyclohexane, chloroform, hexane, toluene, ethanol, or aqueous ammonia) to prepare a sample (a solids concentration of 1 mass % or less), and the average particle diameter of the organic-inorganic composite particles in the sample was measured with a dynamic light scattering photometer (model number: “ZEN3600”, DLS, manufactured by a Sysmex Corporation).

(b) Dispersibility

The dispersibility of a particle dispersion was measured with a dynamic light scattering photometer (model number: “ZEN3600”, manufactured by a Sysmex Corporation). The average particle diameter thus measured was compared with the average particle diameter measured using 1 μM or SEM. If the measured diameters were identical, the dispersion was evaluated as having good dispersibility, and if the measured diameters were greatly different, the dispersion was evaluated as having poor dispersibility.

(4) Agglomerating Properties

The particle dispersion and the film was visually observed by SEM and TEM for the presence or absence of an agglomerate.

(5) Observation with Transmission Electron Microscope (TEM)

(a) Determination of Average Particle Diameter

A particle dispersion (a solids concentration of 1 mass % or less) of organic-inorganic composite particles diluted with a solvent was dropped onto a TEM grid (collodion film, carbon supporting film) and dried, and organic-inorganic composite particles were visually observed with a transmission electron microscope (TEM). An image analysis was performed to calculate the average particle diameter of the organic-inorganic composite particles.

(b) Evaluation of Dispersibility and Agglomerating Properties of Organic-Inorganic Composite Particles in Film

Film was cut, and the cut surface was visually observed with a transmission electron microscope (TEM, H-7650, manufactured by Hitachi High-Technologies Corp.) to examine the state of dispersion of organic-inorganic composite particles.

In the TEM observation, film was embedded in an epoxy resin and cut so as to form a clear cut surface of the film.

(6) Observation with Scanning Electron Microscope (SEM)

(a) Determination of Particle Having Average Particle Diameter of No Less than 200 nm.

A particle dispersion was dripped onto a sample stage, dried, and visually observed with a scanning electron microscope (SEM, S-4800, manufactured by Hitachi High-Technologies Corp., or JSM-7001F, manufactured by JEOL Ltd.) to see the shape and the average particle diameter of organic-inorganic composite particles.

(b) Evaluation of Dispersibility and Agglomerating Properties in Film of Particle Having Average Particle Diameter of No Less than 200 nm

Film was cut, and the cut surface was visually observed with a scanning electron microscope (SEM, S-4800, manufactured by Hitachi High-Technologies Corp.) to see the dispersed state of organic-inorganic composite particles. The film was embedded in an epoxy resin and cut so as to form a clear cut surface of the film.

### Preparation of Organic-Inorganic Composite Particles

### Example 1

Cerium hydroxide (Ce(OH)₄, manufactured by Wako Pure Chemical Industries, Ltd.) serving as an inorganic compound, decanoic acid and hexanoic acid serving as two kinds of organic compounds, and water were charged into a 5 mL high-pressure reactor (SHR-R6-500, manufactured by AKICO Corporation) in amounts presented in Table 1.

The lid of the high-pressure reactor was closed, the reactor was heated to 400° C. in a shaking heating furnace (manufactured by AKICO Corporation), the pressure inside the high-pressure reactor was increased to about 40 MPa due to the amount of water present therein, and shaking was performed for 10 minutes to carry out a hydrothermal synthesis.

Thereafter, the high-pressure reactor was rapidly cooled by being placed in cold water.

Ethanol was then added and stirred, and centrifugation was performed at 15000 G for 20 minutes in a centrifuge (trade name: MX-301, Tomy Seiko Co., Ltd.) to isolate the precipitate (reaction product) from the supernatant (washing step). This washing step was repeated 5 times. Ethanol in the precipitate was then dried by heating at 80° C., giving organic-inorganic composite particles containing a decyl group and a hexyl group, i.e., the two kinds of organic groups, on the surface of cerium oxide (CeO₂).

The organic-inorganic composite particles obtained above and chloroform were charged into a screw cap vial and centrifuged at 4000 G for 5 minutes with a centrifuge (trade name: MX-301, manufactured by Tomy Seiko Co. Ltd.) to separate into a supernatant and a precipitate (wet classification).

The supernatant was then isolated and dried to give organic-inorganic composite particles having a small particle diameter.

Thereafter, the obtained organic-inorganic composite particles were subjected to the above-described (1) XRD, (2) FT-IR, (3) DLS (for average particle diameter), and (5) TEM (for average particle diameter) for evaluation.

As a result, (1) XRD confirmed that the inorganic compound forming the inorganic particles was CeO₂.

(2) FT-IR confirmed that different saturated aliphatic groups (decyl group and hexyl group) were present on the surface of the inorganic particles.

(3) DLS showed that the average particle diameter of the organic-inorganic composite particles was 7 nm. (5) TEM showed that the average particle diameter of the organic-inorganic composite particles was 4 to 10 nm.

The results described above are presented in Table 1.

### Examples 2 to 131 and Comparative Examples 1 to 12

Organic-inorganic composite particles were prepared in the same manner as in Example 1 except that the inorganic substance (inorganic particles), the organic compounds, and water were used according to the formulations presented in Tables 1 to 8. In wet classification, centrifugal gravitational acceleration was suitably altered and, if necessary, filtration with a 100-nm filter was performed.

Then, the obtained organic-inorganic composite particles were evaluated in the same manner as in Example 1. Results are presented in Tables 1 to 8.

TABLE 1

| | Formulation | | | | | | | | | |
|---|---|---|---|---|---|---|---|---|---|---|
| | Inorganic | | | | | | | Carbonic acid | | |
| | substance | | Organic compound | | | | | source | | Water |
| | | Amount | | Amount | | Amount | Amount | Formic | Amount | Amount |
| | Kind | (mL) | | (mL) | | (mL) | (mL) | acid | (mL) | (mL) |
| Ex. 1 | Ce(OH)₄ | 1.09 | Hexanoic acid | 0.3279 | Decanoic acid | 0.5181 | | | | 1.771 |
| Ex. 2 | | 0.0545 | Arachidic acid | 0.2044 | Melissic acid | 0.2962 | | | | 2.116 |
| Ex. 3 | | 0.545 | Benzoic acid | 0.15975 (g) | 6-Phenylhexanoic | 0.2442 | | | | 1.927 |
| Ex. 4 | | 1.56 | | 0.45795 (g) | acid | 0.7000 | | | | 1.342 |
| Ex. 5 | | 0.872 | | 0.2556 (g) | | 0.39072 | | | | 1.447 |
| Ex. 6 | | 1.09 | | 0.3195 (g) | | 0.4884 | | | | 1.809 |
| Ex. 7 | | 0.545 | | 0.15975 (g) | | 0.2442 | | Formic | 0.14925 | 2.308 |
| | | | | | | | | acid | | |
| Ex. 8 | | 1.09 | | 0.31955 (g) | | 0.48835 | | | | 1.238 |
| Ex. 9 | | 1.09 | | 0.51128 (g) | | 0.19534 | | | | 1.339 |
| Ex. 10 | | 1.09 | | 0.12782 (g) | | 0.78136 | | | | 1.137 |
| Ex. 11 | | 0.545 | Cyclohexanecarboxylic | 0.1677 | Trans-4-propylcyclohexane- | 0.2227 | | | | 1.681 |
| | | | acid | | carboxylic acid | | | | | |
| Ex. 12 | | 0.545 | | 0.1677 | Cyclohexanepentanoic | 0.2511 | | | | 1.653 |
| Ex. 13 | | 0.545 | Cyclohexanepropionic | 0.2044 | acid | 0.2511 | | | | 1.616 |
| | | | acid | | | | | | | |
| Ex. 14 | | 0.7807 | Cyclohexanepentanoic | 0.3602 | Butyric acid | 0.1784 | | | | 3.215 |
| | | | acid | | | | | | | |
| Ex. 15 | | 0.7807 | Cyclopentanecarboxylic | 0.204 | Acetic acid | 0.1074 | | | | 3.442 |
| | | | acid | | | | | | | |
| Ex. 16 | | 0.545 | Dicyclohexylacetic | 0.2935 | Cyclohexanepentanoic | 0.2511 | | | | 1.527 |
| | | | acid | | acid | | | | | |
| Ex. 17 | | 0.545 | Decanoic acid | 0.5181 | 2-Ethylhexanoic acid | 0.4165 | | | | 1.682 |
| Ex. 18 | | 0.545 | | 0.5181 | 2-Hexyldecanoic acid | 0.7624 | | | | 1.336 |
| Ex. 19 | | 0.545 | | 0.5181 | 3,5,5-Trimethylhexanoic | 0.4621 | | | | 1.636 |
| Ex. 20 | | 1.09 | | 0.5181 | acid | 0.4621 | | | | 1.636 |
| Ex. 21 | | 0.0545 | | 0.1295 | 6-PhenylHexanoic | 0.1221 | | | | 2.365 |
| | | | | | acid | | | | | |

| | | | | | Organic-inorganic composite particle | | | |
|---|---|---|---|---|---|---|---|---|
| | | | | | | | | Average |
| | High-temperature treatment condition | | | | | | | particle |
| | | | | Reaction | | | | diameter |
| | Synthesis | Temp. | Pressure | time | Inorganic | | | (DLS) |
| | method | ° C. | (MPa) | min | particle | Surface organic group | | (nm) |
| Ex. 1 | Second | 400 | 40 | 10 | CeO₂ | Hexyl | Decyl | 7 |
| | hydrothermal | | | | | | | 4-10*¹ |
| Ex. 2 | synthesis | 400 | 40 | 10 | | Arachidyl | Melissyl | 60 |
| Ex. 3 | | 400 | 40 | 10 | | Phenyl | 6-Phenylhexyl | 4-10*¹ |
| Ex. 4 | | 400 | 40 | 10 | | | | 14 |
| Ex. 5 | | 400 | 40 | 10 | | | | 4-10*¹ |
| Ex. 6 | | 400 | 40 | 10 | | | | 4-8*¹ |
| Ex. 7 | | 400 | 40 | 10 | | | | 14 |
| Ex. 8 | | 400 | 40 | 10 | | | | 12 |
| Ex. 9 | | 400 | 40 | 10 | | | | 10 |
| Ex. 10 | | 400 | 40 | 10 | | | | 10 |
| Ex. 11 | | 400 | 40 | 10 | | Cyclohexyl | Trans-4- | 11 |
| | | | | | | | propylcyclohexyl | |
| Ex. 12 | | 400 | 40 | 10 | | | Cyclohexanepentyl | 12 |
| Ex. 13 | | 400 | 40 | 10 | | Cyclohexylpropyl | | 14 |
| Ex. 14 | | 300 | 30 | 10 | | Cyclohexylpentyl | Propyl | 34 |
| Ex. 15 | | 300 | 30 | 10 | | Cyclopentyl | Ethyl | — |
| Ex. 16 | | 400 | 40 | 10 | | Dicyclohexylethyl | Cyclohexylpentyl | 10 |
| Ex. 17 | | 400 | 40 | 10 | | Decyl | 2-Ethylhexyl | 7 |
| Ex. 18 | | 400 | 40 | 10 | | | 2-Hexyldecyl | 14 |
| Ex. 19 | | 400 | 40 | 10 | | | 3,5,5- | 9 |
| | | | | | | | Trimethylhexyl | |
| Ex. 20 | | 400 | 40 | 10 | | | | 6 |
| Ex. 21 | | 400 | 40 | 10 | | | 6-Phenylhexyl | 4-14*¹ |

*¹Average particle diameter by image analysis (SEM or TEM)

TABLE 2

| | Fomulation | | | | | | | | | |
|---|---|---|---|---|---|---|---|---|---|---|
| | Inorganic | | | | | | | Carbonic acid | | |
| | substance | | | Organic compound | | | | source | | Water |
| | | Amount | | Amount | | Amount | Amount | Formic | Amount | Amount |
| | Kind | (mL) | | (mL) | | (mL) | (mL) | acid | (mL) | (mL) |
| Ex. 22 | Ce(OH)₄ | 0.0545 | Decanoic acid | 0.1295 | Arachidic acid | 0.2044 | | | | 2.283 |
| Ex. 23 | | 0.0545 | | 0.1295 | Melissic acid | 0.2962 | | | | 2.191 |
| Ex. 24 | | 0.545 | | 0.259 | Lauric acid | 0.2621 | | | | 1.810 |
| Ex. 25 | | 0.7807 | Naphthaleneacetic | 0.3494 (g) | Acetic acid | 0.1074 | | | | 3.296 |
| | | | acid | | | | | | | |
| Ex. 26 | | 0.7807 | Norbornene- | 0.25932 (g) | | 0.1074 | | | | 3.387 |
| | | | carboxylic acid | | | | | | | |
| Ex. 27 | | 0.545 | Hexanoic acid | 0.3279 | 2-Ethylhexanoic acid | 0.4165 | | | | 1.872 |
| Ex. 28 | | 1.09 | | 0.3279 | | 0.4165 | | | | 1.872 |
| Ex. 29 | | 0.545 | | 0.3279 | 2-Hexyldecanoic acid | 0.7624 | | | | 1.526 |
| Ex. 30 | | 0.545 | | 0.3279 | 3,5,5-Trimethylhexanoic | 0.4621 | | | | 1.827 |
| | | | | | acid | | | | | |
| Ex. 31 | | 0.0545 | | 0.082 ml | 6-Phenylhexanoic acid | 0.1221 | | | | 2.412 |
| Ex. 32 | | 0.7807 | | 0.23515 | 6-Phenylhexanoic acid | 0.35025 | | | | 3.168 |
| Ex. 33 | | 0.7807 | | 0.37624 | | 0.1401 | | | | 3.237 |
| Ex. 34 | | 0.545 | | 0.26232 | | 0.09768 | | | | 2.257 |
| Ex. 35 | | 0.4293 | | 0.41376 | | 0.15408 | | | | 3.560 |
| Ex. 36 | | 0.7807 | | 0.2352 | Acetic acid | 0.1074 | | | | 3.411 |
| Ex. 37 | | 0.7807 | | 0.2352 | Cyclohexanecarboxylic | 0.2405 | | | | 3.278 |
| | | | | | acid | | | | | |
| Ex. 38 | | 0.7807 | | 0.2352 | Cyclohexanepentanoic | 0.3602 | | | | 3.158 |
| Ex. 39 | | 0.7807 | | 0.0941 | acid | 0.5764 | | | | 3.083 |
| Ex. 40 | | 0.545 | | 0.1639 | | 0.2511 | | | | 2.202 |
| Ex. 41 | | 0.545 | | 0.0656 | | 0.4018 | | | | 2.149 |

| | | | | | Organic-inorganic composite particle | | | |
|---|---|---|---|---|---|---|---|---|
| | | | | | | | | Average |
| | High-temperature treatment condition | | | | | | | particle |
| | | | | Reaction | | | | diameter |
| | Synthesis | Temp. | Pressure | Time | Inorganic | | | (DLS) |
| | method | ° C. | (MPa) | min | particle | Surface organic group | | (nm) |
| Ex. 22 | Second | 400 | 40 | 10 | CeO₂ | Decyl | Arachidyl | 60 |
| Ex. 23 | hydrothermal | 400 | 40 | 10 | | | Melissyl | 20 |
| Ex. 24 | synthesis | 400 | 40 | 10 | | | Lauryl | 4-12*¹ |
| Ex. 25 | | 300 | 30 | 10 | | Naphthaleneethyl | Ethyl | — |
| Ex. 26 | | 300 | 30 | 10 | | Norbornenyl | | — |
| Ex. 27 | | 400 | 40 | 10 | | Hexyl | 2-Ethylhexyl | 7 |
| Ex. 28 | | 400 | 40 | 10 | | | | 6 |
| Ex. 29 | | 400 | 40 | 10 | | | 2-Hexyldecyl | 10 |
| Ex. 30 | | 400 | 40 | 10 | | | 3,5,5- | 6 |
| | | | | | | | Trimethhylhexyl | |
| Ex. 31 | | 400 | 40 | 10 | | | 6-Phenylhexyl | 14 |
| Ex. 32 | | 300 | 30 | 10 | | | 6-Phenylhexyl | 14 |
| Ex. 33 | | 300 | 30 | 10 | | | | 14 |
| Ex. 34 | | 400 | 40 | 10 | | | | 14 |
| Ex. 35 | | 250 | 30 | 10 | | | | 4-15*¹ |
| Ex. 36 | | 300 | 30 | 10 | | | Ethyl | 14 |
| Ex. 37 | | 300 | 30 | 10 | | | Cyclohexyl | 9 |
| Ex. 38 | | 300 | 30 | 10 | | | Cyclohexanepentyl | 12 |
| Ex. 39 | | 300 | 30 | 10 | | | | 9 |
| Ex. 40 | | 400 | 40 | 10 | | | | 22 |
| Ex. 41 | | 400 | 40 | 10 | | | | 9 |

*¹Average particle diameter by image analysis (SEM or TEM)

TABLE 3

| | Formulation | | | | | | | | | | |
|---|---|---|---|---|---|---|---|---|---|---|---|
| | Inorganic | | | | | | | | Carbonic acid | | |
| | substance | | Organic compound | | | | | | source | | Water |
| | | Amount | | Amount | | Amount | | Amount | Formic | Amount | Amount |
| | Kind | (mL) | | (mL) | | (mL) | | (mL) | acid | (mL) | (mL) |
| Ex. 42 | Ce(OH)₄ | 0.545 | Hexanoic | 0.1639 | Cyclopentane- | 0.3145 (g) | | | | | 2.138 |
| | | | acid | | decanoic acid | | | | | | |
| Ex. 43 | | 0.0545 | | 0.082 | Decanoic acid | 0.1295 | | | | | 2.405 |
| Ex. 44 | | 1.09 | | 0.3279 | | 0.5181 | | | | | 1.200 |
| Ex. 45 | | 1.56 | | 0.4699 | | 0.74255 | | | | | 1.288 |
| Ex. 46 | | 0.872 | | 026232 | | 0.41448 | | | | | 1.416 |
| Ex. 47 | | 1.090 | | 0.23515 | | 0.3716 | Butyric | 0.1784 | | | 2.968 |
| Ex. 48 | | 1.09 | | 03279 | | 0.5181 | acid | 0.2487 | | | 1.522 |
| Ex. 49 | | 0.0545 | | 0.1311 | | 0.0518 | | | | | 2.434 |
| Ex. 50 | | 0.0545 | | 0.0328 | | 0.2072 | | | | | 2.377 |
| Ex. 51 | | 0.545 | | 0.1639 | | 0.259 | | | | | 1.908 |
| Ex. 52 | | 1.09 | | 0.5246 | | 0.20724 | | | | | 1.314 |
| Ex. 53 | | 1.09 | | 0.1311 | | 0.82896 | | | | | 1.086 |
| Ex. 54 | | 0.545 | | 0.1639 | Norbornene- | 0.3485 | | | | | 2.104 |
| Ex. 55 | | 0.7807 | | 0.2352 | decanoic acid | 0.5 | | | | | 3.018 |
| Ex. 56 | | 0.0545 | | 0.082 | Melissic acid | 0.296 | | | | | 2.238 |
| Ex. 57 | | 0.0545 | | 0.082 | Laurie acid | 0.131 | | | | | 2.404 |
| Ex. 58 | | 0.7807 | | 0.2352 | Butyric add | 0.1784 | | | | | 3.340 |
| Ex. 59 | | 0.545 | Lauric acid | 0.26205 | Cyclohexane- | 0.2511 | | | | | 2.103 |
| Ex. 60 | | 0.545 | Linolic acid | 0.40765 | pentanoic acid | 0.2511 | | | | | 1.958 |
| Ex. 61 | | 0.545 | Linoleic acid | 0.4003 | | 0.2511 | | | | | 1.965 |

| | | | | | Organic-inorganic composite particle | | | | |
|---|---|---|---|---|---|---|---|---|---|
| | | | | | | | | | Average |
| | High-temperature treatment condition | | | | | | | | particle |
| | | | | Reaction | | | | | diameter |
| | Synthesis | Temp. | Pressure | Time | Inorganic | | | | (DLS) |
| | method | ° C. | (MPa) | min | particle | Surface organic group | | | (nm) |
| Ex. 42 | Second | 400 | 40 | 10 | CeO₂ | Hexyl | Cyclopentane- | | — |
| | hydrothermal | | | | | | decyl | | |
| Ex. 43 | synthesis | 400 | 40 | 10 | | | Decyl | | 8 |
| Ex. 44 | | 400 | 40 | 10 | | | | | 8 |
| Ex. 45 | | 400 | 40 | 10 | | | | | 7 |
| Ex. 46 | | 400 | 40 | 10 | | | | | 8 |
| Ex. 47 | | 300 | 30 | 10 | | | | Butyric | — |
| Ex. 48 | | 400 | 40 | 10 | | | | acid | 8 |
| Ex. 49 | | 400 | 40 | 10 | | | | | 4-9 |
| Ex. 50 | | 400 | 40 | 10 | | | | | 4-10*¹ |
| Ex. 51 | | 400 | 40 | 10 | | | | | 4-9*¹ |
| Ex. 52 | | 400 | 40 | 10 | | | | | 8 |
| Ex. 53 | | 400 | 40 | 10 | | | | | 7 |
| Ex. 54 | | 400 | 40 | 10 | | | Norbornene- | | 21 |
| Ex. 55 | | 300 | 30 | 10 | | | decyl | | 15 |
| Ex. 56 | | 400 | 40 | 10 | | | Melissyl | | 40 |
| Ex. 57 | | 400 | 40 | 10 | | | Lauryl | | 4-10*¹ |
| Ex. 58 | | 300 | 30 | 10 | | | propyl | | 27 |
| Ex. 59 | | 400 | 40 | 10 | | Lauryl | Cyclohexyl | | 15 |
| Ex. 60 | | 400 | 40 | 10 | | Octadeca-cis-9- | | | 20 |
| | | | | | | cis-12-dienyl | | | |
| Ex. 61 | | 400 | 40 | 10 | | Octadeca- | | | — |
| | | | | | | 9,12,15-trienyl | | | |

*¹Average particle diameter by image analysis (SEM or TEM)

TABLE 4

| | Formulation | | | | | | | | | |
|---|---|---|---|---|---|---|---|---|---|---|
| | Inorganic | | | | | | | Carbonic acid | | |
| | substance | | Organic compound | | | | | source | | Water |
| | | Amount | | Amount | | Amount | Amount | Formic | Amount | Amount |
| | Kind | (mL) | | (mL) | | (mL) | (mL) | acid | (mL) | (mL) |
| Ex. 62 | Ce(OH)₄ | 1.09 | 10-Bromodecanoic | 0.6572 (g) | 6-Bromohexanoic acid | 0.5103 (g) | | | | 1.449 |
| | | | acid | | | | | | | |
| Ex. 63 | | 1.09 | 4-Oxovaleric acid | 0.2679 | 7-Oxooctanoic acid | 0.4139 | | | | 1.935 |
| Ex. 64 | | 0.7807 | | 0.2179 | Butyric acid | 0.17835 | | | | 3.357 |
| Ex. 65 | | 0.0545 | 5-Oxohexanoic acid | 0.774 | 6-Phenylhexanoic acid | 0.1221 | | | | 2.417 |
| Ex. 66 | | 0.545 | Erucic acid | 0.51505 | Cyclohexanoic acid | 0.2511 | | | | 1.850 |
| Ex. 67 | | 0.545 | Oleic acid | 0.4166 | | 0.2511 | | | | 1.949 |
| Ex. 68 | | 0.0545 | Decanoic acid | 0.1295 | 10-Undecenoic acid | 0.1205 | | | | 2.367 |
| Ex. 69 | | 0.0545 | | 0.1892 | p-6-Carboxyhexyloxy- | 0.1648 | | | | 3.468 |
| | | | | | benzoic acid | | | | | |
| Ex. 70 | | 0.0545 | Hexanoic acid | 0.1295 | Sebacic acid | 0.1323 | | | | 2.355 |
| Ex. 71 | | 0.0545 | | 0.082 | 10-Undecenoic acid | 0.1205 | | | | 2.414 |
| Ex. 72 | | 0.7807 | | 0.23515 | | 0.3458 | | | | 3.172 |
| Ex. 73 | | 1.09 | | 0.3279 | | 0.4822 | | | | 1.806 |
| Ex. 74 | | 0.7807 | | 0.23515 | | 0.3458 | | | | 3.172 |
| Ex. 75 | | 0.545 | | 0.26232 | | 0.09644 | | | | 2.258 |
| Ex. 76 | | 0.429 | | 0.41376 | | 0.15214 | | | | 3.562 |
| Ex. 77 | | 0.429 | | 0.2586 | | 0.38035 | | | | 3.489 |
| Ex. 78 | | 0.545 | | 0.081975 | 10-Carboxydecanethiol | 0.1428 | | | | 2.392 |
| Ex. 79 | | 0.0545 | | 0.082 | 3-(4-Carboxyphenyl) | 0.1648 | | | | 2.370 |
| | | | | | propionic acid | | | | | |
| Ex. 80 | | 0.0545 | | 0.082 | 4-Hydroxyphenylacetic | 0.0995 | | | | 2.435 |
| | | | | | acid | | | | | |
| Ex. 81 | | 1.09 | | 0.3279 | 6-Hydroxycapronic | 0.3458 | | | | 1.943 |
| | | | | | acid | | | | | |
| Ex. 82 | | 0.0545 | | 0.082 | 6-Hydroxyhexanoic | 0.0864 | | | | 2.448 |
| | | | | | acid | | | | | |
| Ex. 83 | | 0.0545 | | 0.082 | 7-Oxooxtanoic acid | 0.1035 | | | | 2.431 |
| Ex. 84 | | 0.0545 | | 0.1198 | p-6-Carboxyhexyloxy- | 0.1648 | | | | 3.537 |
| | | | | | benzoic acid | | | | | |
| Ex. 85 | | 0.7807 | | 0.23515 | Ethyl 6-hydroxyhexanoate | 0.30525 | | | | 3.213 |
| Ex. 86 | | 0.0545 | | 0.082 | Sebacic acid | 0.1323 | | | | 2.402 |

| | | | | | Organic-inorganic composite particle | | | |
|---|---|---|---|---|---|---|---|---|
| | | | | | | | | Average |
| | High-temperature treatment condition | | | | | | | particle |
| | | | | Reaction | | | | diameter |
| | Synthesis | Temp. | Pressure | Time | Inorganic | | | (DLS) |
| | method | ° C. | (MPa) | min | particle | Surface organic group | | (nm) |
| Ex. 62 | Second | 400 | 40 | 10 | CeO₂ | 10-Bromodecyl | 6-Bromohexyl | — |
| Ex. 63 | hydrothermal | 400 | 40 | 10 | | 4-Oxopentyl | 7-Oxooctyl | 8 |
| Ex. 64 | synthesis | 300 | 30 | 10 | | | Propyl | 200 |
| Ex. 65 | | 400 | 40 | 10 | | 5-Oxohexyl | 6-Phenylhexyl | 3-25*¹ |
| Ex. 66 | | 400 | 40 | 10 | | Cis-docosa-13-enyl | Cyclohexanepentyl | 29 |
| Ex. 67 | | 400 | 40 | 10 | | Oleyl | | 36 |
| Ex. 68 | | 400 | 40 | 10 | | Decyl | 10-Undecenyl | 1-6*¹ |
| Ex. 69 | | 300 | 40 | 10 | | | p-6-Carboxhexyl- | — |
| | | | | | | | oxyphenyl | |
| Ex. 70 | | 400 | 40 | 10 | | | 9-calboxynonyl | |
| Ex. 71 | | 400 | 40 | 10 | | Hexyl | 10-Undecenyl | 1-7*¹ |
| Ex. 72 | | 300 | 30 | 10 | | | | 8 |
| Ex. 73 | | 400 | 40 | 10 | | | | 8 |
| Ex. 74 | | 300 | 30 | 10 | | | | 8 |
| Ex. 75 | | 400 | 40 | 10 | | | | 8 |
| Ex. 76 | | 250 | 30 | 10 | | | | 3-8*¹ |
| Ex. 77 | | 250 | 30 | 10 | | | | 34* |
| Ex. 78 | | 400 | 40 | 10 | | | 10-Mercaptodecyl | 15 |
| Ex. 79 | | 400 | 40 | 10 | | | 3-(4-Carboxyphenyl) | — |
| | | | | | | | propyl | |
| Ex. 80 | | 400 | 40 | 10 | | | 4-Hydroxyphenylethyl | 5-20*¹ |
| Ex. 81 | | 400 | 40 | 10 | | | 6-Hydroxyhexyl | 8 |
| Ex. 82 | | 400 | 40 | 10 | | | 6-Hydroxyhexyl | — |
| Ex. 83 | | 400 | 40 | 10 | | | 7-oxooctyl | 2-15*¹ |
| Ex. 84 | | 300 | 40 | 10 | | | p-6-Carboxyhexyl- | — |
| | | | | | | | oxyphenyl | |
| Ex. 85 | | 300 | 30 | 10 | | | 6-Hydroxyhexyl | 10 |
| Ex. 86 | | 400 | 40 | 10 | | | 10-Carboxyoctyl | — |

*¹Average particle diameter by image analysis (SEM or TEM)

TABLE 5

| | Formulation | | | | | | | | | | |
|---|---|---|---|---|---|---|---|---|---|---|---|
| | Inorganic | | | | | | | | Carbonic acid | | |
| | substance | | | Organic compound | | | | | source | | Water |
| | | Amount | | Amount | | Amount | Amount | | Formic | Amount | Amount |
| | Kind | (mL) | | (mL) | | (mL) | (mL) | | acid | (mL) | (mL) |
| Ex. 87 | Ti | 0.1 | Ethyl 6- | 0.1763 | Ethyl 3- | 0.1559 | | | | | 2.284 |
| | complex | | (diethoxyphos- | | (diethoxyphos- | | | | | | |
| | | | phonyl)hexanate | | phonyl)propionate | | | | | | |
| Ex. 88 | | 0.1 | 3-Phosphonopropionic | 0.02015 | 6-Phosphonohexanoic | 0.02565 | | | | | 2.571 |
| | | | acid | | acid | | | | | | |
| Ex. 89 | | 0.1 | 6-Phosphonohexanoic | 0.02565 | Methylphosphonic | 0.01255 | | | | | 2.578 |
| | | | acid | | acid | | | | | | |
| Ex. 90 | | 0.1 | Ethyl 10- | 0.044 | | 0.01255 | | | | | 2.560 |
| | | | (diethoxyphos- | | | | | | | | |
| | | | phonyl)decanoate | | | | | | | | |
| Ex. 91 | | 0.5 | Decylphosphonic acid | 0.1455 | | 0.06275 | | | | | 2.560 |
| Ex. 92 | | 0.1 | Ethyl 10- | 0.044 | 3-Phosphonopropionic | 0.0312 | | | | | 2.541 |
| | | | (diethoxyphos- | | acid | | | | | | |
| | | | phonyl)decanoate | | | | | | | | |
| Ex. 93 | | 0.1 | 3-Phosphoropropionic | 0.02015 | 6-Phosphonohexanoic | 0.02565 | | | | | 2.571 |
| | | | acid | | acid | | | | | | |
| Ex. 94 | | 0.1 | Ethyl 3- | 0.03115 | Ethyl 6- | 0.03525 | | | | | 2.550 |
| | | | (diethoxyphos- | | (diethoxyphos- | | | | | | |
| | | | phonyl)propionate | | phonyl)hexanoate | | | | | | |
| Ex. 95 | | 0.1 | Ethyl 10- | 0.044 | Diethyl | 0.03275 | | | | | 2.540 |
| | | | (diethoxyphos- | | octylphosphonate | | | | | | |
| | | | phonyl)decanoate | | | | | | | | |
| Ex. 96 | | 0.4 | 6-Phosphonohexanoic | 0.05888 | Methylphosphonic | 0.1152 | | | | | 2.828 |
| | | | acid | | acid | | | | | | |
| Ex. 97 | | 0.4 | 3-Phosphonopropionic | 0.04624 | | 0.1152 | | | | | 2.841 |
| | | | acid | | | | | | | | |
| Ex. 98 | | 0.400 | Diethyl | 0.1310 | Ethyl 10- | 0.176 | Decyl- | 0.1164 | | | 2.193 |
| Ex. 99 | | 0.400 | octylphosphonate | 0.1310 | (diethoxyphos- | 0.176 | phosphonic | 0.0720 | | | 2.238 |
| | | | | | phonyl)decanoate | | | | | | |
| Ex. 100 | | 0.5 | Methylphosphonic | 0.1440 | 3-Phosphonopropionic | 0.0403 | acid | 0.0655 | | | 2.407 |
| | | | acid | | acid | | | | | | |
| Ex. 101 | | 0.5 | | 0.1440 | 6-Phosphonohexanoic | 0.0513 | | 0.0655 | | | 2.407 |
| | | | | | acid | | | | | | |

| | | | | | Organic-inorganic composite particle | | | | |
|---|---|---|---|---|---|---|---|---|---|
| | | | | | | | | | Average |
| | High-temperature treatment | | | | | | | | particle |
| | | | | Reaction | | | | | diameter |
| | Synthesis | Temp. | Pressure | Time | Inorganic | | | | (DLS) |
| | method | ° C. | (MPa) | min | particle | Surface organic group | | | (nm) |
| Ex. 87 | Second | 400 | 40 | 10 | TiO₂ | 5-calboxypentil | 2-calboxyethyl | | 2-10*¹ |
| Ex. 88 | hydrothermal | 400 | 40 | 10 | | 2-calboxyethyl | 5-calboxypentil | | 4-16*¹ |
| Ex. 89 | synthesis | 400 | 40 | 10 | | 5-calboxypentil | Methyl | | 4-14*¹ |
| Ex. 90 | | 400 | 40 | 10 | | 9-calboxynonyl | | | 4-24*¹ |
| Ex. 91 | | 400 | 40 | 10 | | Decyl | | | 4-18*¹ |
| Ex. 92 | | 400 | 40 | 10 | | 9-calboxynonyl | 2-calboxyethyl | | 4-8*¹ |
| Ex. 93 | | 400 | 40 | 10 | | 2-calboxyethyl | 5-calboxypentil | | — |
| Ex. 94 | | 400 | 40 | 10 | | 2-calboxyethyl | 5-calboxypentil | | — |
| Ex. 95 | | 400 | 40 | 10 | | 9-calboxynonyl | Octyl | | 4-15*¹ |
| Ex. 96 | | 300 | 30 | 10 | | 5-calboxypentil | Methyl | | |
| Ex. 97 | | 300 | 30 | 10 | | 2-calboxyethyl | | | — |
| Ex. 98 | | 400 | 40 | 10 | | Octyl | 9-calboxynonyl | Decyl | 3-12*¹ |
| Ex. 99 | | 400 | 40 | 10 | | | | | 3-40*¹ |
| Ex. 100 | | 400 | 40 | 10 | | Methyl | 2-calboxyethel | | — |
| Ex. 101 | | 400 | 40 | 10 | | | 5-calboxypentil | | — |

*¹Average particle diameter by image analysis (SEM or TEM)

TABLE 6

| | Formulation | | | | | | | | | | |
|---|---|---|---|---|---|---|---|---|---|---|---|
| | Inorganic | | | | | | | | Carbonic acid | | |
| | substance | | Organic compound | | | | | | source | | Water |
| | | Amount | | Amount | | Amount | | Amount | Formic | Amount | Amount |
| | Kind | (mL) | | (mL) | | (mL) | | (mL) | acid | (mL) | (mL) |
| Ex. 102 | Ti | 0.5 | Diethyl | 0.2620 | Ethyl 10-(diethoxy- | 0.088 | Decyl- | 0.0582 | | | 2.296 |
| | complex | | octylphosphonate | | phosphonyl)decanoate | | phosphonic | | | | |
| Ex. 103 | | 0.5 | Methylphosphonic | 0.1440 | | 0.088 | acid | 0.0582 | | | 2.326 |
| Ex. 104 | | 0.5 | acid | 0.0720 | | 0.088 | | 0.1164 | | | 2.340 |
| Ex. 105 | | 0.4 | Diethyl | 0.1310 | | 0.088 | | 0.1164 | | | 2.369 |
| Ex. 106 | | 0.4 | octylphosphonate | 0.1965 | | 0.176 | | 0.0582 | | | 2.617 |
| Ex. 107 | | 0.5 | | 0.1310 | | 0.088 | | 0.1164 | | | 2.281 |
| Ex. 108 | | 0.5 | Decanoic acid | 0.25905 | Hexanoic acid | 0.16395 | | | | | 2.194 |
| Ex. 109 | | 0.5 | Ethyl 10-(diethoxy- | 0.22 | Diethyl | 0.1638 | | | | | 2.233 |
| Ex. 110 | | 0.5 | phosphonyl)decanoate | 0.044 | octylphosphonate | 0.2948 | | | | | 2.278 |
| Ex. 111 | | 0.5 | | 0.088 | | 0.2620 | | | | | 2.267 |
| Ex. 112 | | 0.5 | | 0.088 | | 0.2620 | | | | | 2.267 |
| Ex. 113 | | 0.5 | Diethyl | 0.1638 | Diethyl | 0.182 | | | | | 2.453 |
| | | | octylphosphonate | | decylphosphonate | | | | | | |
| Ex. 114 | | 0.5 | | 0.1310 | Ethyl 10-(diethoxy- | 0.176 | Decyl- | 0.1164 | | | 2.193 |
| Ex. 115 | | 0.5 | | 0.1310 | phosphonyl)decanoate | 0.088 | phosphonic | 0.1164 | | | 2.369 |
| | | | | | | | acid | | | | |
| Ex. 116 | | 0.1 | | 0.1310 | | 0.176 | Diethyl | 0.1456 | | | 2.164 |
| | | | | | | | decyl- | | | | |
| | | | | | | | phosphonate | | | | |

| | | | | | Organic-inorganic composite particle | | | | |
|---|---|---|---|---|---|---|---|---|---|
| | | | | | | | | | Average |
| | High-temperature treatment condition | | | | | | | | particle |
| | | | | Reaction | | | | | diameter |
| | Synthesis | Temp. | Pressure | Time | Inorganic | | | | (DLS) |
| | method | ° C. | (MPa) | min | particle | Surface organic group | | | (nm) |
| Ex. 102 | Second | 400 | 40 | 10 | TiO₂ | Octyl | 9-calboxynonyl | Decyl | 4-13*¹ |
| Ex. 103 | hydrothermal | 400 | 40 | 10 | | Methyl | | | — |
| Ex. 104 | synthesis | 400 | 40 | 10 | | | | | 4-12*¹ |
| Ex. 105 | | 400 | 40 | 10 | | Octyl | | | 10 |
| Ex. 106 | | 400 | 40 | 10 | | | | | — |
| Ex. 107 | | 400 | 40 | 10 | | | | | 20 |
| Ex. 108 | | 400 | 40 | 10 | | Decyl | Hexyl | | |
| Ex. 109 | | 400 | 40 | 10 | | 9-calboxynonyl | Octyl | | — |
| Ex. 110 | | 400 | 40 | 10 | | | | | 4-8*¹ |
| Ex. 111 | | 400 | 40 | 10 | | | | | 4-8*¹ |
| Ex. 112 | | 400 | 40 | 10 | | | | | — |
| Ex. 113 | | 400 | 40 | 10 | | Octyl | Decyl | | 4-8*¹ |
| Ex. 114 | | 400 | 40 | 10 | | | 9-calboxynonyl | Decyl | — |
| Ex. 115 | | 400 | 40 | 10 | | | | | — |
| Ex. 116 | | 400 | 40 | 10 | | | | | — |

*¹Average particle diameter by image analysis (SEM or TEM)

TABLE 7

| | Formulation | | | | | | | | | |
|---|---|---|---|---|---|---|---|---|---|---|
| | Inorganic | | | | | | | Carbonic acid | | |
| | substance | | Organic compound | | | | | source | | Water |
| | | Amount | | Amount | | Amount | Amount | Formic | Amount | Amount |
| | Kind | (mL) | | (mL) | | (mL) | (mL) | acid | (mL) | (mL) |
| Ex. 117 | Si(OH)₂•8H₂O | 0.5 | Decanoic acid | 0.2332 | Hexanoic acid | 0.1475 | | Formic | 0.0896 | 1.88455 |
| Ex. 118 | | 1.5 | | 0.2591 | | 0.1640 | | acid | 0.2488 | 1.6831 |
| Ex. 119 | | 0.3 | | 0.1768 | | 0.1119 | | | 0.0679 | 1.430 |
| Ex. 120 | | 0.3 | | 0.2591 | | 0.1640 | | | 0.0995 | 2.094 |
| Ex. 121 | SrCO₃ | 0.5 | Norbornene- | 0.5 | Hexanoic acid | 0.2352 | | | | 3.018 |
| | | | decanoic acid | | | | | | | |
| Ex. 122 | | 0.5 | | 0.25 | Hexanoic acid | 0.1176 | | | | 3.386 |
| Ex. 123 | | 0.5 | Decanoic acid | 0.1858 | Hexanoic acid | 0.1176 | | | | 3.450 |
| Ex. 124 | | 0.5 | Cyclopentane- | 0.2255 (g) | Hexanoic acid | 0.1176 | | | | 3.410 |
| | | | decanoic acid | | | | | | | |
| Ex. 125 | | 0.5 | Octanoic acid | 0.1274 | 3-Phenylpropionic | 0.0439 | | | | 3.207 |
| | | | | | acid | | | | | |
| Ex. 126 | | 0.5 | 6-Phenylhexanoic | 0.2604 | 3,3- | 0.077 | | | | 3.416 |
| Ex. 127 | | 0.5 | acid | 0.1628 | Diphenylpropionic | 0.192 | | | | 3.399 |
| Ex. 128 | | 0.5 | | 0.0651 | acid | 0.306 | | | | 3.382 |
| Ex. 129 | | 0.5 | | 0.2604 | 4-Biphenylacetic | 0.072 | | | | 3.421 |
| Ex. 130 | | 0.5 | | 0.1628 | acid | 0.180 | | | | 3.411 |
| Ex. 131 | | 0.5 | | 0.0651 | | 0.287 | | | | 3.401 |

| | | | | | Organic-inorganic composite particle | | | |
|---|---|---|---|---|---|---|---|---|
| | | | | | | | | Average |
| | High-temperature treatment condition | | | | | | | particle |
| | | | | Reaction | | | | diameter |
| | Synthesis | Temp. | Pressure | Time | Inorganic | | | (DLS) |
| | method | ° C. | (MPa) | min | particle | Surface organic group | | (nm) |
| Ex. 117 | Second | 400 | 40 | 10 | SrCO₃ | Decyl | Hexyl | Minor axis: |
| | hydrothermal | | | | | | | 0.5-0.8 μm |
| | synthesis | | | | | | | Longer axis: |
| | | | | | | | | 7-15 μm*¹ |
| Ex. 118 | | 400 | 40 | 10 | | | | — |
| Ex. 119 | | 400 | 30 | 10 | | | | — |
| Ex. 120 | | 400 | 40 | 10 | | | | Minor axis: |
| | | | | | | | | 0.01-0.04 μm |
| | | | | | | | | Longer axis: |
| | | | | | | | | 0.04-0.2 μm*¹ |
| Ex. 121 | First | 300 | 30 | 10 | | Norbomenedecyl | | Minor axis: |
| | hydrothermal | | | | | | | 0.14-0.21 μm |
| | synthesis | | | | | | | Longer axis: |
| | | | | | | | | 0.4-1 μm*¹ |
| Ex. 122 | | 300 | 30 | 10 | | | | Same as above |
| Ex. 123 | | 300 | 30 | 10 | | Decyl | | Same as above |
| Ex. 124 | | 300 | 30 | 10 | | Cyclopentyl | | Same as above |
| Ex. 125 | | 300 | 30 | 10 | | Octyl | 3-Phenylpropyl | Same as above |
| Ex. 126 | | 300 | 30 | 10 | | 6-Phenylhexyl | 3,3- | Same as above |
| Ex. 127 | | 300 | 30 | 10 | | | Diphenylpropyl | Same as above |
| Ex. 128 | | 300 | 30 | 10 | | | | Same as above |
| Ex. 129 | | 300 | 30 | 10 | | | 4-Biphenylethyl | Same as above |
| Ex. 130 | | 300 | 30 | 10 | | | | Same as above |
| Ex. 131 | | 300 | 30 | 10 | | | | Same as above |

*¹Average particle diameter by image analysis (SEM or TEM)

TABLE 8

| | Formulation | | | | | | | | |
|---|---|---|---|---|---|---|---|---|---|
| | Inorganic | | | | | | Carbonic acid | | |
| | substance | | Organic compound | | | | source | | Water |
| | | Amount | | Amount | Amount | Amount | Formic | Amount | Amount |
| | Kind | (mL) | | (mL) | (mL) | (mL) | acid | (mL) | (mL) |
| Comp. | Ce(OH)₄ | 0.0545 | Decanoic acid | 0.1961 | | | | | 2.420 |
| Ex. 1 | | | | | | | | | |
| Comp. | | 0.0545 | Hexanoic acid | 0.2395 | | | | | 3.582 |
| Ex. 2 | | | | | | | | | |
| Comp. | | 0.0545 | | | | | | | 2.617 |
| Ex. 3 | | | | | | | | | |
| Comp. | | 0.7807 | 3,5,5-Trimethylhexanoic acid | 0.663 | | | | | 3.091 |
| Ex. 4 | | | | | | | | | |
| Comp. | | 0.545 | Trans-4-propylcyclohexane | 0.4455 | | | | | 2.171 |
| Ex. 5 | | | carboxylic acid | | | | | | |
| Comp. | | 0.7807 | Cyclohexanecarboxylic acid | 0.4810 | | | | | 2.492 |
| Ex. 6 | | | | | | | | | |
| Comp. | | 1.09 | 2-Hexyldecanoic acid | 1.5248 | | | | | 1.092 |
| Ex. 7 | | | | | | | | | |
| Comp. | | 0.545 | 6-Phenylhexanoic acid | 0.1258 | | | | | 2.491 |
| Ex. 8 | | | | | | | | | |
| Comp. | | 0.545 | Benzoic acid | 0.1598 | | | | | 2.457 |
| Ex. 9 | | | | | | | | | |
| Comp. | Ti | 0.5 | Decylphophonate | 0.364 | | | | | 2.253 |
| Ex. 10 | complex | | | | | | | | |
| Comp. | | 0.5 | Ethyl 10- | 0.44 | | | | | 2.177 |
| Ex. 11 | | | (Diethoxyphosphonyl)decanoate | | | | | | |
| Comp. | | 0.5 | Diethyl octylphosphonate | 0.3275 | | | | | 2.289 |
| Ex. 12 | | | | | | | | | |

| | | | | | Organic-inorganic composite particle | | |
|---|---|---|---|---|---|---|---|
| | | | | | | | Average |
| | High-temperature treatment condition | | | | | | particle |
| | | | | Reaction | | | diameter |
| | Synthesis | Temperature | Pressure | Time | Inorganic | | (DLS) |
| | method | ° C. | (MPa) | min | particle | Surface organic group | (nm) |
| Comp. | Second | 400 | 40 | 10 | CeO₂ | Decyl | 7 |
| Ex. 1 | hydrothermal | | | | | | |
| Comp. | synthesis | 300 | 40 | 10 | | Hexyl | 8 |
| Ex. 2 | | | | | | | |
| Comp. | | 400 | 40 | 10 | | | — |
| Ex. 3 | | | | | | | |
| Comp. | | 300 | 30 | 10 | | 3,5,5-Trimethylhexyl | — |
| Ex. 4 | | | | | | | |
| Comp. | | 400 | 40 | 10 | | Trans-4-propylcyclohexyl | — |
| Ex. 5 | | | | | | | |
| Comp. | | 300 | 30 | 10 | | Cyclohexyl | — |
| Ex. 6 | | | | | | | |
| Comp. | | 400 | 40 | 10 | | 2-Hexyldecyl | — |
| Ex. 7 | | | | | | | |
| Comp. | | 400 | 40 | 10 | | 6-Phenylhexyl | — |
| Ex. 8 | | | | | | | |
| Comp. | | 400 | 40 | 10 | | Benzyl | — |
| Ex. 9 | | | | | | | |
| Comp. | Second | 400 | 40 | 10 | TiO₂ | Decyl | 2-8*¹ |
| Ex. 10 | hydrothermal | | | | | | |
| Comp. | synthesis | 400 | 40 | 10 | | 9-calboxynonyl | 4-20*¹ |
| Ex. 11 | | | | | | | |
| Comp. | | 400 | 40 | 10 | | Octyl | 2-8*¹ |
| Ex. 12 | | | | | | | |

*¹Average particle diameter by image analysis (SEM or TEM)

### Preparation of Particle Dispersion

### Preparation Example 1

According to Tables 9 to 19, the organic-inorganic composite particles of each example and a good solvent (a solvent that has compatibility with the mutually different organic groups) were blended so as to prepare particle dispersions having an organic-inorganic composite particle concentration of 1 mass %.

Thereafter, the obtained particle dispersions were evaluated in terms of (3) DLS (dispersibility) and (4) agglomerating property.

The results are presented in Tables 9 to 19.

Dispersibility was evaluated according to the following criteria:

Good: In a particle dispersion where organic-inorganic composite particles were dispersed in a solvent, the precipitate after 1 day accounted for less than 1 wt %, and the organic-inorganic composite particles were dispersed as primary particles nearly uniformly in the solvent.

Fair: In a particle dispersion where organic-inorganic composite particles were dispersed in a solvent, the precipitate after 1 day accounted for less than 1 wt %, and the organic-inorganic composite particles were dispersed nearly uniformly in the solvent; or the precipitate after 1 day accounted for 1 wt % to less than 10 wt %, and the organic-inorganic composite particles were dispersed as primary particles nearly uniformly in the solvent.

Poor: In a particle dispersion where organic-inorganic composite particles were dispersed in a solvent, the precipitate after 1 day accounted for 10 wt % or greater, and the organic-inorganic composite particles were agglomerated in the solvent.

TABLE 9

| | | | | | Dispersibility evaluation | |
|---|---|---|---|---|---|---|
| | Organic-inorganic composite particle | | | | Mass % of organic-inorganic composite | |
| | Composition | | | | particle in particle | |
| | of inorganic | | | | dispersion (solvent: chloroform) | |
| No. | particle | Surface organic group | | | 1 | 10 |
| Ex. 1 | CeO₂ | Decyl group | Hexyl group | | Good | Good |
| Ex. 20 | CeO₂ | 3,5,5-Trimelhylhexyl group | Decyl group | | Good | Good |
| Ex. 28 | CeO₂ | 2-Ethylhexyl group | Hexyl group | | Good | Good |
| Ex. 5 | CeO₂ | 6-Phenylhexyl group | Phenyl group | | Good | Good |
| Ex. 113 | TiO₂ | Decyl group | Octyl group | | Good | Good |
| Ex. 107 | TiO₂ | Decyl group | Octyl group | 9-carboxynonyl group | Good | Good |
| Comp. Ex. 1 | CeO₂ | Decyl group | | | Good | Poor |
| Comp. Ex. 2 | CeO₂ | Hexyl group | | | Good | Poor |
| Comp. Ex. 3 | CeO₂ | | | | Poor | Poor |
| Comp. Ex. 4 | CeO₂ | 3,5,5-Trimethylhexyl group | | | Poor | Poor |
| Comp. Ex. 7 | CeO₂ | 2-Ethylhexyl group | | | Fair | Poor |
| Comp. Ex. 9 | CeO₂ | Phenyl group | | | Poor | Poor |
| Comp. Ex. 8 | CeO₂ | 6-Phenylhexyl group | | | Good | Poor |
| Comp. Ex. 12 | TiO₂ | Decyl group | | | Good | Poor |
| Comp. Ex. 10 | TiO₂ | Octyl group | | | Good | Poor |
| Comp. Ex. 11 | TiO₂ | 9-carbpxynonyl group | | | Poor | Poor |

TABLE 10

| | | | | Dispersibility evaluation | |
|---|---|---|---|---|---|
| | Organic-inorganic composite particle | | | Mass % of organic-inorganic composite particle | |
| | Composition of | | | in particle dispersion (solvent: tetrahydrofuran) | |
| No. | inorganic particle | Surface organic group | | 1 | 10 |
| Ex. 1 | CeO₂ | Decyl group | Hexyl group | Good | Good |
| Comp. | CeO₂ | Decyl group | | Good | Poor |
| Ex. 1 | | | | | |
| Comp. | CeO₂ | Hexyl group | | Good | Poor |
| Ex. 2 | | | | | |
| Comp. | CeO₂ | | | Poor | Poor |
| Ex. 3 | | | | | |

TABLE 11

| | | | | Dispersibility evaluation | |
|---|---|---|---|---|---|
| | Organic-inorganic composite particle | | | Mass % of organic-inorganic composite particle | |
| | Composition of | | | in particle dispersion (solvent: hexane) | |
| No. | inorganic particle | Surface organic group | | 1 | 10 |
| Ex. 1 | CeO₂ | Decyl group | Hexyl group | Good | Good |
| Comp. | CeO₂ | Decyl group | | Good | Poor |
| Ex. 1 | | | | | |
| Comp. | CeO₂ | Hexyl group | | Good | Poor |
| Ex. 2 | | | | | |
| Comp. | CeO₂ | | | Poor | Poor |
| Ex. 3 | | | | | |

TABLE 12

| | | | | Dispersibility evaluation | |
|---|---|---|---|---|---|
| | | | | Mass % of organic-inorganic composite | |
| | Organic-inorganic composite particle | | | particle in particle dispersion (solvent: | |
| | Composition of | | | toluene) | |
| No. | inorganic particle | Surface organic group | | 1 | 10 |
| Ex. 34 | CeO₂ | 6-Phenylhexyl group | Hexyl group | Good | Good |
| Comp. | CeO₂ | Phenyl group | | Poor | Poor |
| Ex. 9 | | | | | |
| Comp. | CeO₂ | 6-Phenylhexyl group | | Poor | Poor |
| Ex. 8 | | | | | |
| Comp. | CeO₂ | | | Poor | Poor |
| Ex. 3 | | | | | |

TABLE 13

| | | | | | Dispersibility evaluation | |
|---|---|---|---|---|---|---|
| | Organic-inorganic composite particle | | | | Mass % of organic-inorganic composite | |
| | Composition | | | | particle in particle | |
| | of inorganic | | | | dispersion (solvent: dichloroethane) | |
| No. | particle | Surface organic group | | | 1 | 10 |
| Ex. 1 | CeO₂ | Decyl group | Hexyl group | | Good | Good |
| Ex. 113 | TiO₂ | Decyl group | Octyl group | | Good | Good |
| Ex. 107 | TiO₂ | Decyl group | Octyl group | 9-carboxynonyl group | Good | Good |
| Comp. Ex. 3 | CeO₂ | | | | Poor | Poor |
| Comp. Ex. 1 | CeO₂ | Decyl group | | | Good | Poor |
| Comp. Ex. 2 | CeO₂ | Hexyl group | | | Good | Poor |
| Comp. Ex. 12 | TiO₂ | Decyl group | | | Fair | Poor |
| Comp. Ex. 10 | TiO₂ | Octyl group | | | Fair | Poor |
| Comp. Ex. 11 | TiO₂ | 9-carboxynonyl group | | | Poor | Poor |

TABLE 14

| | | | | Dispersibility evaluation | |
|---|---|---|---|---|---|
| | Organic-inorganic composite particle | | | Mass % of organic-inorganic composite particle | |
| | Composition of | | | in particle dispersion (solvent: cyclohexane) | |
| No. | inorganic particle | Surface organic group | | 1 | 10 |
| Ex. 11 | CeO₂ | Cyclohexyl group | Propylcyclohexyl | Good | Good |
| | | | group | | |
| Comp. | CeO₂ | Propylcyclohexyl | | Good | Poor |
| Ex. 5 | | group | | | |
| Comp. | CeO₂ | Cyclohexyl group | | Poor | Poor |
| Ex. 6 | | | | | |
| Comp. | CeO₂ | | | Poor | Poor |
| Ex. 3 | | | | | |

TABLE 15

| | Organic-inorganic composite particle | | | Dispersibility evaluation | | | | | | | |
|---|---|---|---|---|---|---|---|---|---|---|---|
| | Composition | | | Mass % of organic-inorganic composite particle in | | | | | | | |
| | of inorganic | | | particle dispersion (solvent: chloroform) | | | | | | | |
| No. | particle | Surface organic group | | 1 | 10 | 30 | 40 | 50 | 60 | 70 | 80 |
| Ex. 1 | CeO₂ | Decyl group | Hexyl group | Good | Good | Good | Good | Good | Good | Fair | Fair |
| Ex. 28 | CeO₂ | 2-Ethylhexyl group | Hexyl group | Good | Good | Good | Good | Good | Good | Good | Fair |
| Ex. 5 | CeO₂ | 6-Phenylhexyl group | Phenyl group | Good | Good | Good | Good | Good | Good | Good | Fair |

TABLE 16

| | Organic-inorganic composite particle | | | Dispersibility evaluation | | | | | | |
|---|---|---|---|---|---|---|---|---|---|---|
| | Composition | | | Mass % of organic-inorganic composite particle in | | | | | | |
| | of inorganic | | | particle dispersion (solvent: tetrahydrofuran) | | | | | | |
| No. | particle | Surface organic group | | 1 | 10 | 30 | 40 | 50 | 60 | 70 |
| Ex. 1 | CeO₂ | Decyl group | Hexyl group | Good | Good | Good | Good | Good | Fair | Fair |

TABLE 17

| | Organic-inorganic composite particle | | | Dispersibility evaluation | | | | | | | |
|---|---|---|---|---|---|---|---|---|---|---|---|
| | Composition | | | Mass % of organic-inorganic composite particle in | | | | | | | |
| | of inorganic | | | particle dispersion (solvent: hexane) | | | | | | | |
| No. | particle | Surface organic group | | 1 | 10 | 30 | 40 | 50 | 60 | 70 | 80 |
| Ex. 1 | CeO₂ | Decyl group | Hexyl group | Good | Good | Good | Good | Good | Good | Good | Fair |

TABLE 18

| | Organic-inorganic composite particle | | | Dispersibility evaluation | | | | | | |
|---|---|---|---|---|---|---|---|---|---|---|
| | Composition | | | Mass % of organic-inorganic composite particle in | | | | | | |
| | of inorganic | | | particle dispersion (solvent: toluene) | | | | | | |
| No. | particle | Surface organic group | | 1 | 10 | 30 | 40 | 50 | 60 | 70 |
| Ex. 34 | CeO₂ | 6-Phenylhexyl group | Hexyl group | Good | Good | Good | Good | Good | Fair | Fair |

TABLE 19

| | | | | Dispersibility evaluation | | | | |
|---|---|---|---|---|---|---|---|---|
| | Organic-inorganic composite particle | | | Mass % of organic-inorganic | | | | |
| | Composition | | | composite particle in particle | | | | |
| | of inorganic | | | dispersion (solvent: cyclohexane) | | | | |
| No. | particle | Surface organic group | | 1 | 10 | 30 | 40 | 50 |
| Ex. 11 | CeO₂ | Cyclohexyl group | Trans-4- | Good | Good | Good | Good | Fair |
| | | | propylcyclohexyl | | | | | |
| | | | group | | | | | |

### Preparation Example 2

A polyarylate resin (polyarylate resin of Example 4 of Japanese Unexamined Patent Publication No. 2009-80440) was blended with good solvents of Tables 20 to 22 (cyclohexane, chloroform, hexane, toluene, ethanol, and aqueous ammonia) so as to prepare resin solutions having a solids concentration of 10 mass %.

The particles of Examples 1, 3 to 10, 12, 13, 19, 20, 27, 28, 43 to 46, 49 to 55, 59, 66, 67, 117 and 120 to 124 were blended with the good solvents of Tables 20 to 22 so as to prepare particle dispersions having a solids concentration of 10 mass %.

The resin solutions and the particle dispersions were then blended such that the proportion of organic-inorganic composite particle was 10 mass % relative to the total amount of resin and organic-inorganic composite particle, and the organic-inorganic composite particles were dispersed in the resin solutions using an ultrasonic disperser, thus giving transparent particle-dispersed resin composition varnishes.

Next, the obtained varnishes were applied to a support using a spin coat method.

The applied particle-dispersed resin compositions were then dried at 50° C. for 1 hour (first-stage drying) and dried at 100° C. for 10 minutes (second-stage drying) so as to prepare films having a thickness of 8 μm (particle-dispersed resin articles).

Thereafter, the obtained films were evaluated in terms of (4) agglomerating properties described above.

The criteria of agglomerating property evaluation are given below:

Good: Organic-inorganic composite particles were dispersed as primary particles nearly uniformly in a resin.

The results are presented in Tables 20 to 22.

TABLE 20

| | | Prep. Ex. 2 | |
|---|---|---|---|
| | Prep. Ex. 1 | | Dispersibility of organic-inorganic |
| Ex. | Good solvent | Resin | composite particle in film |
| Ex. 1 | Hexane | Polyarylate | Good |
| Ex. 3 | Chloroform | | Good |
| Ex. 4 | Chloroform | | Good |
| Ex. 5 | Chloroform | | Good |
| Ex. 6 | Chloroform | | Good |
| Ex. 7 | Chloroform | | Good |
| Ex. 8 | Chloroform | | Good |
| Ex. 9 | Chloroform | | Good |
| Ex. 10 | Chloroform | | Good |
| Ex. 12 | Chloroform | | Good |
| Ex. 13 | Cyclohexane | | Good |
| Ex. 19 | Chloroform | | Good |
| Ex. 20 | Chloroform | | Good |
| Ex. 27 | Chloroform | | Good |
| Ex. 28 | Chloroform | | Good |
| Ex. 43 | Hexane | | Good |
| Ex. 44 | Hexane | | Good |
| Ex. 45 | Hexane | | Good |

TABLE 21

| | | Prep. Ex. 2 | |
|---|---|---|---|
| | Prep. Ex. 1 | | Dispersibility of organic-inorganic |
| Ex. | Good solvent | Resin | composite particle in film |
| Ex. 46 | Hexane | Polyarylate | Good |
| Ex. 49 | Hexane | | Good |
| Ex. 50 | Hexane | | Good |
| Ex. 51 | Chloroform | | Good |
| Ex. 52 | Chloroform | | Good |
| Ex. 53 | Chloroform | | Good |
| Ex. 54 | Cyclohexane | | Good |
| Ex. 55 | Cyclohexane | | Good |
| Ex. 59 | Cyclohexane | | Good |
| Ex. 66 | Cyclohexane | | Good |
| Ex. 67 | Cyclohexane | | Good |

TABLE 22

| | | Prep. Ex. 2 | |
|---|---|---|---|
| | Prep. Ex.1 | | Dispersibility of organic-inorganic |
| Ex. | Good solvent | Resin | composite particle in film |
| Ex. 117 | Chloroform | Polyarylate | Good |
| Ex. 120 | Chloroform | | Good |
| Ex. 121 | Chloroform | | Good |
| Ex. 122 | Chloroform | | Good |
| Ex. 123 | Chloroform | | Good |
| Ex. 124 | Chloroform | | Good |

While the illustrative embodiments of the present invention were provided in the above description, they are for illustrative purposes only and not to be construed limiting. Modification and variation of the present invention that will be obvious to those skilled in the art is to be covered by the following claims.

What is claimed is:

1. Organic-inorganic composite particles that can be dispersed as primary particles in a solvent and/or a resin, and that have a plurality of mutually different organic groups on a surface of inorganic particles.

2. The organic-inorganic composite particles according to claim 1, produced in a high-temperature solvent.

3. The organic-inorganic composite particles according to claim 1, produced in a high-temperature, high-pressure solvent.

4. The organic-inorganic composite particles according to claim 1, wherein the plurality of organic groups are organic groups each having a different number of main-chain atoms and/or organic groups each having a different main-chain molecular structure.

5. The organic-inorganic composite particles according to claim 4, wherein the plurality of organic groups are hydrocarbon groups each having a different number of main-chain carbon atoms and/or hydrocarbon groups each having a different main-chain molecular structure.

6. The organic-inorganic composite particles according to claim 1, wherein
at least one of the plurality of organic groups is a functional group-containing organic group at least comprising a functional group in a side chain or at a terminal, and
when two or more of the organic groups are the functional group-containing organic groups, the organic groups each have a different functional group or a different number of main-chain atoms.

7. The organic-inorganic composite particles according to claim 6, wherein
at least one of the plurality of organic groups is a functional group-containing hydrocarbon-based group comprising at least a hydrocarbon group and a functional group bonded to the hydrocarbon group, and
when two or more of the organic groups are the functional group-containing hydrocarbon-based groups, the hydrocarbon-based groups each have a different functional group or a different number of main-chain carbon atoms.

8. A particle dispersion comprising:
a solvent, and
organic-inorganic composite particles that are dispersed as primary particles in the solvent and that have a plurality of mutually different organic groups on a surface of inorganic particles.

9. A particle-dispersed resin composition comprising:
a resin, and
organic-inorganic composite particles that are dispersed as primary particles in the resin and that have a plurality of mutually different organic groups on a surface of inorganic particles.

10. A method for producing organic-inorganic composite particles, comprising treating inorganic particles and a plurality of mutually different organic compounds at a high temperature to treat a surface of the inorganic particles with the plurality of organic compounds,
the plurality of organic compounds comprising organic groups and a linker that can be bonded to the surface of the inorganic particles,
the organic groups being mutually different.
